(19) United States
(12) Patent Application Publication
(10) Pub. No.: US 2023/0342902 A1
(43) Pub. Date: Oct. 26, 2023

(54) METHOD AND SYSTEM FOR AUTOMATED EVALUATION OF ANIMALS

(71) Applicant: ICLASSIFIER INC., Edmonton (CA)

(72) Inventors: Ghader Manafiazar, Bedford (CA); Amir Reza Alizad-Rahvar, Edmonton (CA); Ebrahim Parcham, Edmonton (CA); Reza Sabbagh, Edmonton (CA)

(21) Appl. No.: 18/138,592

(22) Filed: Apr. 24, 2023

Related U.S. Application Data
(60) Provisional application No. 63/333,724, filed on Apr. 22, 2022.
(60) Provisional application No. 63/333,735, filed on Apr. 22, 2022.

(51) Int. Cl. G06T 7/00; G06V 40/10; G06V 10/77; G06V 20/70; G06T 7/73; G06V 10/82

(52) U.S. Cl. CPC G06T 7/0002; G06V 40/10; G06V 10/7715; G06V 20/70; G06T 7/73; G06V 10/82; G06T 2207/20084; G06T 2207/10028; G06T 2207/10048; G06T 2200/24; G06T 2207/20081

(57) ABSTRACT

Embodiments herein generally relate to a method and system for automated evaluation of animals. In at least one embodiment, the method comprises: accessing sensor data acquired of an animal; analyzing the sensor data to generate derivative sensor data; applying feature extraction to one or more of the sensor data and derivative sensor data to extract trait-specific feature data associated with the one or more target traits use for evaluating the animal; and generating one or more evaluation scores for the animal, for each of the one or more target traits, based on the extracted trait-specific feature data for these target traits.

### CROSS-REFERENCE TO RELATED APPLICATIONS

The present application claims the priority benefit of both U.S. Provisional Application 63/333,724 filed on Apr. 22, 2022, and U.S. Provisional Application 63/333,735 filed on Apr. 22, 2022, the entire contents of which are incorporated herein by reference.

### FIELD

Various embodiments are described herein that generally relate to evaluation of animals (e.g., livestock), and in particular, to a method and system for automated evaluation of animals, including evaluating animal health, welfare and/or body structure.

### BACKGROUND

The following is not an admission that anything discussed below is part of the prior art or part of the common general knowledge of a person skilled in the art.

By the year 2050, the world population is expected to exceed ten billion. Without significant advancements in food production, it is anticipated that food scarcity issues will emerge as a significant concern.

To that end, a large source of food production results from raising domesticated animals (e.g., livestock) in agricultural settings. These animals produce commodities (e.g., meat and milk), as well provide necessary labor for outputting agricultural products. In particular, it is believed that producers and consumers generally prioritize healthier animals having higher output at lower costs, as well as good animal welfare. It is therefore important to monitor key health and welfare indicators for domesticated animals to ensure efficient food production.

Various human-based management systems and practices currently exist to monitor animal health and welfare. One example system uses linear type (i.e., body conformation) traits scoring, or classification. This type of assessment involves a comprehensive evaluation of the physical structure of an animal (e.g., dairy cattle or horse), and is commonly used to determine productivity, reproduction, health, and longevity of the animal. Another example type of assessment is a lameness evaluation, which is applied to certain animals (e.g., dairy cows). This assessment type can allow for early detection and prevention of serious diseases and loss of productivity.

Existing human-based assessments, however, suffer from distinct drawbacks. More generally, these assessments are often based on a “naked-eye” observation of each animal. Accordingly, the assessments are error prone, and depend heavily on the ability of humans to subjectively observe animals' conditions and characteristics. Additionally, human-based assessments are labor-intensive, inconsistent between human evaluators, and are often unrepeatable between subsequent evaluations by the same or different evaluators.

### SUMMARY OF VARIOUS EMBODIMENTS

Aspect 1A: A method for automated evaluation of animals, comprising: accessing sensor data acquired of an animal; analyzing the sensor data to generate derivative sensor data; applying feature extraction to one or more of the sensor data and derivative sensor data to extract trait-specific feature data associated with one or more target traits used for evaluating the animal; and generating one or more evaluation scores for the animal, for each of the one or more target traits, based on the extracted trait-specific feature data for these target traits.

Aspect 1B: A system for automated evaluation of animals, comprising: an evaluation apparatus comprising one or more sensors, and at least one processor coupled to the one or more sensors, the at least one processor being configured for: operating the one or more sensors to generate sensor data of an animal being evaluated; and transmitting the sensor data to at least one server; and the at least one server comprising at least one server processor configured for: receiving the sensor data from the evaluation apparatus; analyzing the sensor data to generate derivative sensor data; applying feature extraction to one or more of the sensor data and derivative sensor data to extract trait-specific feature data associated with one or more target traits used for evaluating the animal; and generating one or more evaluation scores for the animal, for each of the one or more target traits, based on the extracted trait-specific feature data for these target traits.

Aspect 1C: An evaluation apparatus for evaluating animals comprising: one or more sensors; at least one processor coupled to the one or more sensors, and configured for: accessing sensor data acquired of the animal; analyzing the sensor data to generate derivative sensor data; applying feature extraction to one or more of the sensor data and derivative sensor data to extract trait-specific feature data associated with the one or more target traits used for evaluating the animal; and generating one or more evaluation scores for the animal, for each of the one or more target traits, based on the extracted trait-specific feature data for these target traits.

Aspect 2: The method of Aspect 1A, the system of Aspect 1B and/or the evaluation apparatus of Aspect 1C, wherein the sensor data comprises one or more of: two-dimensional (2D) image data generated by one or more 2D imaging sensors; depth sensor data generated by one or more depth sensors; and infrared (IR) sensor data generated by one or more IR sensors; and depth sensor data generated by applying monocular depth estimation to the two-dimensional (2D) image data.

Aspect 3: The method of Aspect 1A, the system of Aspect 1B, the evaluation apparatus of Aspect 1C, and/or Aspect 2, wherein generating the derivative sensor data comprises generating derivative 2D image sensor data by one or more of: applying a trained object detection machine learning model to the 2D image data to generate an object annotated 2D image with indicia of the location of the animal in the 2D image; applying a trained body part detection machine learning model to the object annotated 2D image to generate a body part annotated 2D image, the body part annotated 2D image comprising indicia of the locations of different animal body parts; and applying a trained landmark detection machine learning model to the body part annotated 2D image to generate landmark data.

Aspect 4: The method of Aspect 1A, the system of Aspect 1B, the evaluation apparatus of Aspect 1C, and/or any one of Aspects 2 and 3, wherein the applying the landmark detection machine learning model comprises: applying a trained backbone network which receives the 2D image data and extracts one or more features relevant to landmark detection; applying a trained head network comprising a convolutional neural network (CNN), wherein the CNN receives the extracted features and the 2D image, and identifies indicia corresponding to candidate landmarks, wherein the CNN applies region-wide landmark detection using three sizes of masks, and further, determines a confidence score for each detected candidate landmark detected in each mask size; and selecting, from the candidate landmarks, the landmark with highest score for each instance of the region-wise landmark detection.

Aspect 5: The method of Aspect 1A, the system of Aspect 1B, the evaluation apparatus of Aspect 1C, and/or any one of Aspects 2 to 4, wherein generating the derivative 2D image sensor data further comprises: applying, to the object annotated 2D image, three-dimensional (3D) pose estimation to generate 3D pose estimation data.

Aspect 6: The method of Aspect 1A, the system of Aspect 1B, the evaluation apparatus of Aspect 1C, and/or any one of Aspects 2 to 5, wherein generating the derivative 2D image sensor data further comprises: applying, to the object annotated 2D image, three-dimensional (3D) pose estimation to generate 3D pose estimation data.

Aspect 7: The method of Aspect 1A, the system of Aspect 1B, the evaluation apparatus of Aspect 1C, and/or any one of Aspects 2 to 6, further comprising applying 2D feature extraction based on one or more of: (i) the object annotated 2D image, (ii) the body part annotated 2D image, (iii) the landmark data and (iv) the 3D pose estimation data, to extract one or more features related to the one or more target traits.

Aspect 8: The method of Aspect 1A, the system of Aspect 1B, the evaluation apparatus of Aspect 1C, and/or any one of Aspects 2 to 7, wherein generating the derivative sensor data comprises generating derivative depth sensor data by: in some examples, converting depth sensor data of the animal into point cloud data; applying 3D coordinate registration to the point cloud data to generate registered point cloud data; using the 3D coordinate registered data to generate a 3D model reconstruction of the animal; and applying 2D to 3D landmark projection to generate 3D landmark data.

Aspect 9: The method of Aspect 1A, the system of Aspect 1B, the evaluation apparatus of Aspect 1C, and/or any one of Aspects 2 to 8, further comprising applying 3D feature extraction based on one or more of: (i) the registered point cloud data; (ii) the reconstructed 3D model data; and (iii) the 3D landmark data, to extract one or more features related to the one or more target traits.

Aspect 10: The method of Aspect 1A, the system of Aspect 1B, the evaluation apparatus of Aspect 1C, and/or any one of Aspects 2 to 9, further comprising: applying IR pixel mapping calibration between the IR data and the 2D image to generate IR pixel mapped image data; and applying IR feature extraction to one or more of: (i) IR data; and (ii) IR pixel mapped data.

Aspect 11: The method of Aspect 1A, the system of Aspect 1B, the evaluation apparatus of Aspect 1C, and/or any one of Aspects 2 to 10, wherein the one or more evaluation scores are stored in association with an animal profile, and the evaluation scores are output on a display interface of a user device.

Aspect 12: The method of Aspect 1A, the system of Aspect 1B, the evaluation apparatus of Aspect 1C, and/or any one of Aspects 2 to 11, wherein the evaluation apparatus comprises one or more of an automated evaluation assembly (AEA), and a user device.

Aspect 13: The method of Aspect 1A, the system of Aspect 1B, the evaluation apparatus of Aspect 1C, and/or any one of Aspects 2 to 12, wherein the at least one processor of the evaluation apparatus is included in a controller of the AEA, and the AEA further comprises: (i) a frame structure for supporting the one or more sensors; and (ii) an area for receiving the animal being evaluated.

Aspect 14: The method of Aspect 1A, the system of Aspect 1B, the evaluation apparatus of Aspect 1C, and/or any one of Aspects 2 to 12, wherein the user device hosts a mobile application which is executed by the at least one processor, the mobile application being configured to operate the one or more sensors, and transmit the sensor data to the at least one server, the mobile application also being configured to receive the evaluation scores from the at least one server and display the evaluation scores on a display interface of the user device.

Aspect 15: A method for evaluation of animals, comprising or consisting essentially of any combination of elements or features disclosed herein.

Aspect 16: A system for evaluation of animals, comprising any combination of steps, elements or features disclosed herein.

Aspect 17: An evaluation apparatus for evaluation of animals, comprising any combination of steps, elements or features disclosed herein.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example system for automated evaluation of animals.

FIG. 2A is a schematic illustration of an example automated evaluation assembly.

FIG. 2B is a side perspective view of an example automated evaluation assembly, according to an example embodiment.

FIG. 2C is a rear perspective view of the example automated evaluation assembly of FIG. 2A.

FIG. 3A is an example method for automated evaluation of animals.

FIG. 3B is an example method for automated evaluation of animals, using one or more sensor types.

FIG. 3C is an example method for generating derivative two-dimensional (2D) image sensor data.

FIG. 3D is an example method for generating derivative depth sensor data.

FIG. 4 is an example process for feature extraction.

FIG. 5 is an example architecture for 2D landmark detection using one or more trained machine learning models.

FIG. 6A shows example detected landmarks on a side view image of a cow.

FIG. 6B shows example detected landmarks on a rear view image of a cow.

FIG. 6C shows example detected landmarks on an image of a cow's udder.

FIG. 6D shows example detected landmarks on an image of a cow's hoof.

FIG. 6E shows an example body part annotated 2D image.

FIG. 7A shows example RGB and IR images of a healthy cow hoof.

FIG. 7B shows example RGB and IR images of a cow hoof experiencing lameness.

FIG. 7C shows example RGB and IR images of a healthy cow udder.

FIG. 7D shows example RGB and IR images of a cow udder experiencing symptoms of mastitis/infection.

FIGS. 8A-8E show various example screenshots of a graphical user interface (GUI) of a mobile application hosted on a user device.

FIG. 9A is an example simplified hardware block diagram for an automated evaluation assembly.

FIG. 9B is an example simplified hardware/software block diagram for a user device.

Further aspects and features of the example embodiments described herein will appear from the following description taken together with the accompanying drawings.

### DESCRIPTION OF VARIOUS EMBODIMENTS

As disclosed, embodiments herein allow for evaluating of animals. This includes evaluating key health, welfare, and body structure indicators.

### I. GENERAL OVERVIEW

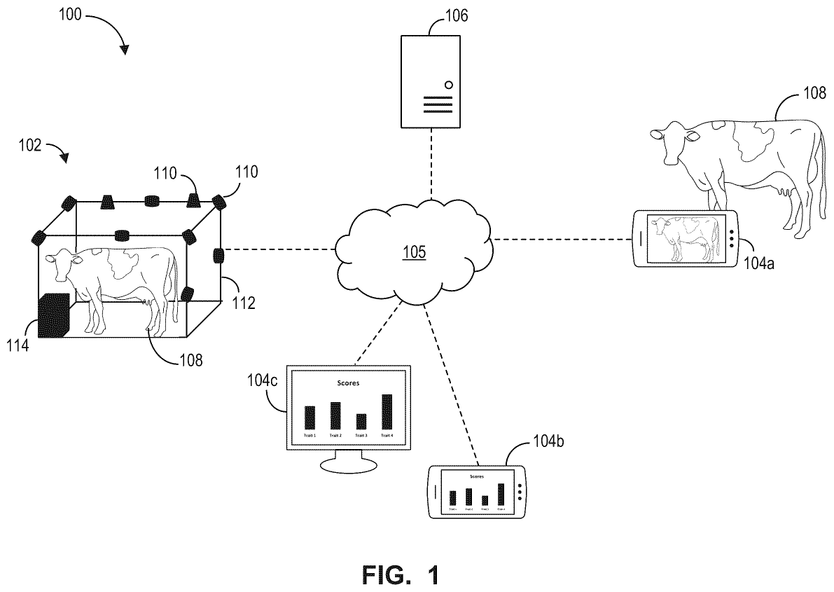

Reference is now made to FIG. 1, which shows an example system (100) for automated evaluation of animals.

As described herein, system (100) allows for automated identification, monitoring, and evaluation of an animal's state. As used herein, an animal's state refers broadly to various traits relating to animal health, welfare, and/or body structure. By way of non-limiting examples, this can include identifying an animal and monitoring and evaluating it for conformation traits, structural traits, locomotive traits, and/or linear animal traits, as well various animal health traits (e.g., structural or metabolic disorders).

In an example agricultural application, system (100) is used for evaluating various traits relevant to an animal's production value and production quality (e.g., animal carcass).

By way of example, when evaluating a cow, system (100) can evaluate various traits, such as linear composite traits. Linear composite traits are defined by breed associations such as the World Holstein Friesian Federation (WHFF), and varies among countries and animal types. Linear composite traits include at least eighteen body structure-related traits (e.g., stature, chest width, body depth, etc.). Most countries use a scale from 1 to 9, or from 0 to 50.

More generally, system (100) can be used to automatically evaluate both “quantitative traits” and “qualitative traits”.

As used herein, “quantitative traits” refer to physical and measurable characteristics of an animal that can be objectively scored or measured. These include body weight, height, length, or distance, angles, and the relative positions of different points on the body, as well as physiological parameters like heart rate and blood pressure in different parts of the body (e.g. udder). These traits can be typically quantified using numerical values.

As further used herein, “qualitative traits” are more subjective characteristics that are difficult to measure objectively, such as the animal's overall appearance and lameness. These traits are often evaluated traditionally through visual inspection, and their values may be expressed using descriptive or categorical terms. However, while these traits are qualitative, they can be assigned numerical values, such as a score on a lameness scale or a rating of an animal's overall appearance.

As noted in the background, current mechanisms for assessing animal traits have primarily relied on “naked-eye” observation and/or using simpler tools such as rulers, which are error prone, especially for qualitative trait assessment.

While embodiments herein are explained primarily in relation to identifying, monitoring and evaluating livestock (e.g., cows), it will be understood that the same concepts and principles are readily applied to any other type of animal, without limitation. For example, the disclosed systems and methods can monitor and evaluate animals used as pets (e.g. dogs), as well as various domesticated animals, and animals used for recreational purposes (e.g., racing horses). In each case, the animals are automatically evaluated by system (100) with respect to a set of pre-defined traits.

As shown in FIG. 1, system (100) generally includes a network (105) coupled to one or more “evaluation apparatus” that can include: (i) an automated evaluation assembly (AEA) (102), and/or (ii) at least one user device (104) (collectively, and individually, referred to as “evaluation apparatus”). System (100) can also include one or more servers (106) (e.g., a cloud server), connected to network (105).

Automated evaluation assembly (AEA) (102) provides one example evaluation apparatus for evaluating an animal's state. More generally, AEA (102) defines an area for receiving an animal (108) for evaluation, such as a cow (108). In other examples, assembly (102) can receive any other animal.

As described, the AEA (102) includes a sensor subsystem (110), which includes various types of sensors for monitoring and evaluating animal (108). For instance, sensor subsystem (110) can include one or more of two-dimensional (2D) imaging sensors (e.g., Red-Green-Blue wavelength (RGB) cameras), depth or three-dimensional (3D) sensors (e.g., RGB-Depth (RGB-D) cameras, or other time-of-flight (ToF) sensors), infrared (IR) sensors, ultrasound sensors, weight sensors and the like.

As used herein, reference to a system component (e.g., an evaluation apparatus, such as AEA (102) and/or user device (104)) including or comprising a sensor subsystem (110) includes example cases where that system component is coupled to one or more external sensors. It also includes examples where one or more sensors are integrated into that system component.

In the exemplified embodiment, sensors (110) are mounted to various areas and locations around a mounting frame structure (112) of AEA (102). The sensors (110) can be arranged to fully or partially surround the animal (108). The positioning of the sensors around the animal (108) allows sensor data to be captured from different viewpoints and angles around the animal (108). In turn, this can allow for a holistic evaluation of the animal (108).

In use, sensor subsystem (110) is operated to capture a plurality of images, as well as other sensor data (e.g., depth data, IR sensor data, weight data etc.), of an animal's body.

As disclosed, acquired (e.g., captured) sensor data can be processed to evaluate various traits related to the health, welfare, and/or body structure of animals (108) (e.g., an animal's state).

In some examples, sensor data is processed to generate numerical scores relating to health-related traits, welfare-related traits, and/or body structure-related traits. Sensor data can also be processed to generate non-numerical assessments and appraisals (e.g., classifying a trait as “good”, “medium” or “poor”).

Sensor data can also be used, more generally, for animal identification.

In at least one example, system (100) utilizes a pipeline of machine learning and computer vision models and techniques to process captured sensor data with a view to evaluating target traits. The processing techniques and tools can vary flexibly depending on the specific trait being evaluated, as well as the type of sensor data available.

Continuing with reference to FIG. 1, automated evaluation assembly (102) can also include a controller (114). Controller (114) couples to the sensor system (110), and receives sensor data therefrom.

In at least one example, controller (114) processes and analyzes the sensor data to evaluate an animal's traits. For example, the controller (114) can store and execute the various machine learning and computer vision models used for processing the sensor data.

In other examples, controller (114) collects generated sensor data, and transmits the sensor data to server (106) (e.g., via network (105)), for further processing. Controller (114) can also perform some partial processing before transmitting the raw and/or partially processed data to server (106). In these examples, the machine learning and computer vision models are stored on server (106), and/or distributed between the server (106) and controller (114).

In at least one example, server (106) stores a profile in association with each animal. Each profile includes various raw and/or processed sensor data related to that animal. Controller (114) can upload acquired sensor data to the animal's profile on server (106).

In examples where controller (114) interacts with the server (106)—the sensor data can be transmitted from controller (114) to server (106) in real-time, or near reap time. In other cases, the sensor data is initially stored on controller (114), and transmitted at a later point in time to server (106). This may be advantageous if, for example, controller (114) is not initially connected to network (105), or is initially offline, when the sensor data is originally captured.

In addition to, or in the alternative, to the automated evaluation assembly (AEA) (102)—system (100) can also include a user device (104a), User device (104a) can provide another evaluation apparatus, separate from the AEA (102), for evaluating an animal (108). In some examples, the user device (104a) provides a convenient and/or portable alternative to AEA (102).

More generally, user device (104a) may be equipped, or connected to, its own sensor system (110). The sensor system (110) can be the same or different than the sensor system (110) used by AEA (102). Sensor data generated by the device's sensors can likewise be processed directly by the user device (104a), or otherwise, transmitted in raw and/or partially processed format to server (106), for further processing.

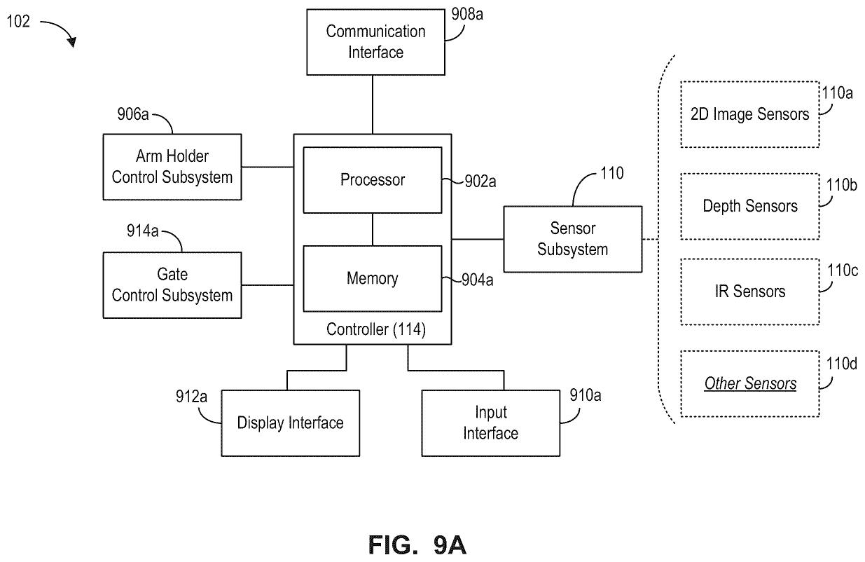

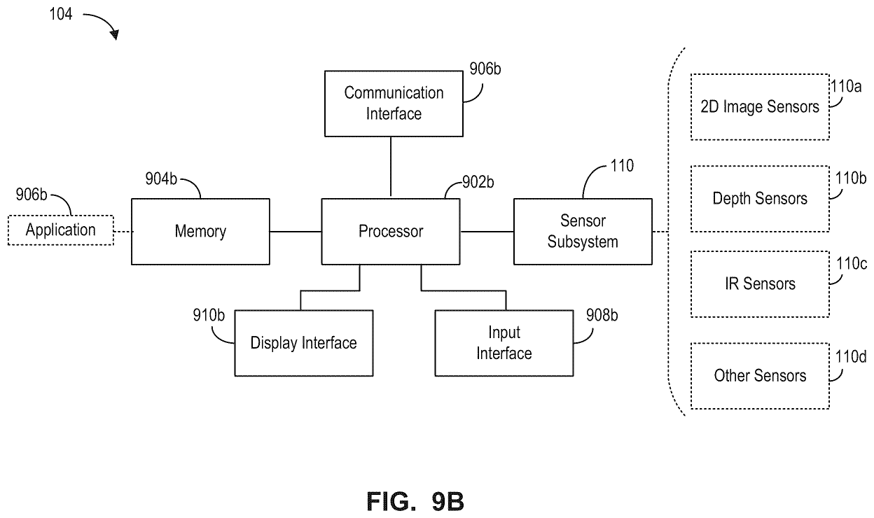

In some examples, user device (104a) hosts a mobile application (e.g., application (906b) in FIG. 9B). The application can include a graphical user interface (GUI) that allows a user to interact with the application.

In at least one example, the application allows the user to operate the user device's sensor system in order to capture sensor data. The application can also guide the user in capturing sensor data. For example, if multiple images of the animal (108) are required (e.g., images of different parts of the animal), the application GUI can guide the user to the location and/or type of image—or other sensor data—required. The application can then either process the sensor data, or transmit the sensor data to server (106) for further processing.

In examples where the user device (104a) interacts with the server (106)—the sensor data can be transmitted to server (106) in real-time, or near real-time. In other cases, the sensor data is stored and transmitted later (e.g., if the device is not connected to network (105), or is offline, when the sensor data is captured).

The mobile application can also enable the user to access and monitor the results of the sensor data processing. For example, using the application, a user can review a summary report (e.g., evaluation report) of the various evaluated animal traits. This can be displayed back to the user, in association with the animal's profile (see e.g., user devices (104b) and (104c)). In this manner, the application is used for tracking various animal traits over time.

Where multiple animals (108) are monitored, the mobile application can also manage to aggregate all evaluation data, for all animals. For example, in an example farming application—the application can act as a farm managing tool, for tracking and managing different animals under different profiles. The generated evaluation reports can summarize various metrics for these animals, individually or collectively. Evaluation reports can also summarize metrics for herds of animals within the farm.

Server (106) is any suitable computing device, and may comprise one or more servers (e.g., cloud servers). Server (106) may store various software, programs, algorithms and routines for processing raw or partially processed sensor data. This can include, for example, sensor data received from one or more the automated evaluation assembly (102) and/or a user device (104a).

As discussed above, server (106) may also store animal profiles, with any associated raw, partially-processed or fully processed data. This data can be received either from automated evaluation assembly (102) and/or user devices (104).

Network (105) can be implemented through various types of networks or combinations thereof, including but not limited to: wide area networks (WANs) such as the Internet, local area networks (LANs), Peer-to-Peer (P2P) networks, telephone networks, private networks, public networks, packet networks, circuit-switched networks, wired networks, and/or wireless networks. Computer systems and/or computing devices can communicate with each other via the network (105) using different communication protocols (such as Internet communication protocols, WAN communication protocols, LAN communication protocols, P2P protocols, telephony protocols, and/or other network communication protocols), various authentication protocols, and different types of data (such as web-based data types, audio data types, video data types, image data types, messaging data types, signaling data types, and/or other data types).

### II. EXAMPLE AUTOMATED EVALUATION ASSEMBLY (AEA)

The following is a description of an automated evaluation assembly (102). The automated evaluation assembly (AEA) (102) can be used as stand-alone, or it can be combined with any feature or element disclosed herein. As detailed previously, the AEA (102) is used for automated capturing of sensor data of an animal (108).

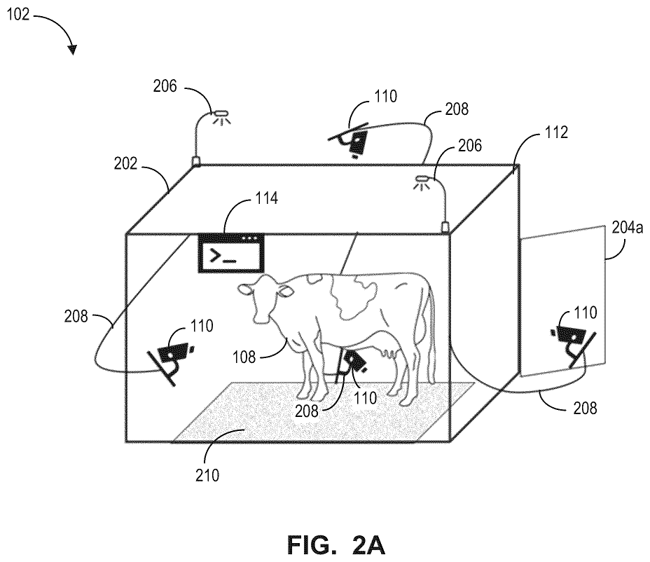

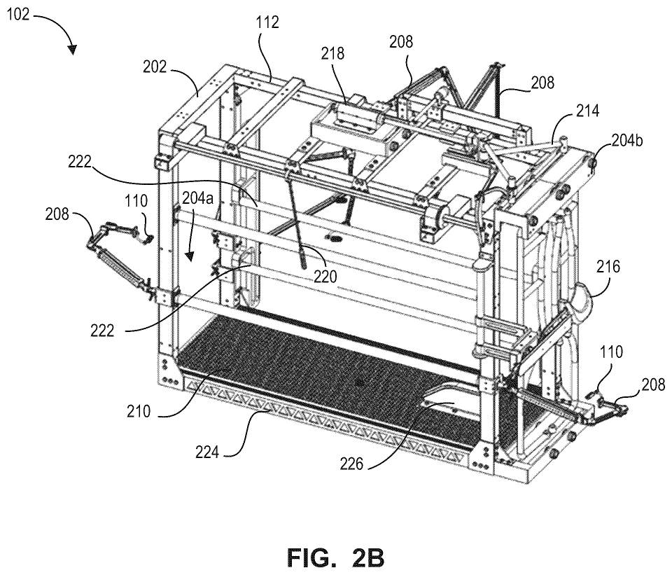

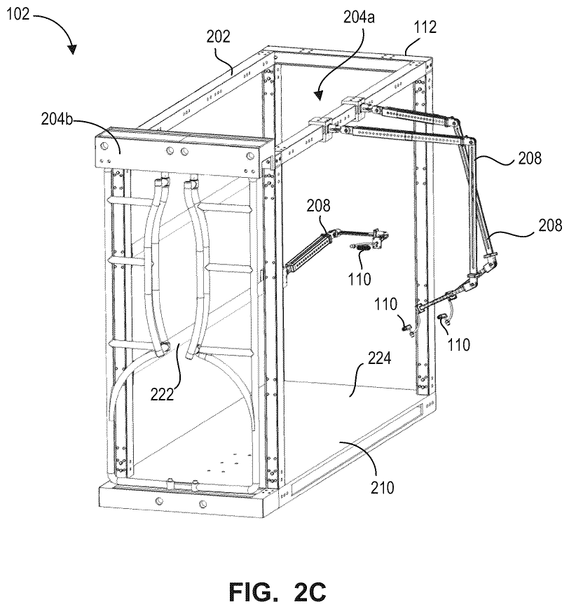

Reference is now made to FIGS. 2A-2C, which show various illustrations of an example automated evaluation assembly (102).

As shown, assembly (102) can utilize a stock (202), which includes a frame (112) (e.g., a cage). Stock (202) may restrict motion of the animal (108), while it is being evaluated.

More generally, stock (202) can hold the animal (108) for a predetermined period of time using gate(s) (204a) and/or a headlock system (204b) (FIG. 2C).

To that end, as shown in FIG. 2B, stock (202) can include gates (204a) that open to allow the animal (108) to enter the stock (202), and that close to keep the animal (108) within the stock (202). The stock (202) also has the ability to hold the animal (108) using locking mechanisms (214) and (216) that may lock the head of the animal in the headlock mechanism (204b). The headlock mechanism (204b) can operate automatically using the open/shut mechanism (214) and/or the pneumatic/hydraulic system (218). The gates (204a) and headlock (204b) can activate electrically and/or mechanically using the top mechanical handle (220).

More generally, the gates (204a) and/or head lock system (204b) may be operated manually or automatically. In some examples, stock (202) can restrain animal (108) through a fully automated (no human involvement) process, a semi-automated process with some human involvement, or a manual backup process.

Automated evaluation assembly (102) can also include moveable bars (222). Bars (222) can guide the animal (108) to remain in the assembly (102), and can be moved or removed at imaging time so as not to block any sensor or camera views. Assembly (102) can also include bottom guides (226) (FIG. 2B) which keep the animal (108) in the middle of the stock (112), with respect to the side bars (222). The guides (226) can be fixed or removed as necessary for different usage of the stock (202).

A platform (210) can also be included, which the animal (108) can stand over. Platform (210) can be a static platform or a moving platform. A moving platform (210), such as a treadmill, can cause the animal (108) to walk in place. For example, the moving platform (208) can be used for evaluating gait problems in the animal.

In cases where a moving platform is used, the moving platform (210) can be activated manually by the human operator or automatically through the controller (114). The slope, the direction and the speed of the moving platform can be adjusted for simulating variety of animal's walking, galloping, or running scenarios.

Assembly (102) can also include a sensor system (110). The sensor system (110) can include various types of two-dimensional (2D) imaging sensors, depth or three-dimensional (3D) imaging sensors, infrared (IR) and thermal imaging sensors.

In some examples, the sensors (e.g., cameras) are installed at different locations and positions around the assembly frame (112). As discussed, this allows the sensors to capture sensor data from various positions and angles around the animal (108). For example, sensors (e.g., cameras) can be positioned to capture views from behind, in-front, above, below and on either side of the animal (108).

As shown in FIGS. 2B and 2C, frame (112) can have one or more sensor holder arms (208) to adjust the sensor positions and view angles with respect to the animal body. The holder arms (208) can be positioned manually or automatically via controller (114).

Sensor system (110) can also include other sensors, including ultrasonic sensors and weight sensors.

Ultrasonic range sensors can be installed on different sides and the top of the stock (202). These sensors can measure the distance between the animal body and the sensors, which can estimate animal body size parameters such as length, depth, and width. In some examples, this information is used to estimate the weight of the animal or evaluate conformation traits such as the shape and proportion of the body or for other purposes.

Assembly (102) can be further equipped with weight sensors (224) (FIG. 2B). The weight sensors can measure the animal weight, which is useful in evaluating various animal traits (e.g., health status). The weight sensors (224) may be a mechanical, electronic or other types of weight scale. In some cases, the weight sensors (224) are incorporated into the platform (210).

While not shown, assembly (112) can include a tag reading sensor (e.g., an RFID reading sensor). This can be used to scan an identification tag (e.g., RFID tag) attached to the animal (108) in order to identify the animal (108). Animals also can be identified using image processing, as described further on.

In some examples, the identification tag, or identification determined by image processing, is used to associate the animal with a corresponding animal profile. In this manner, sensor data acquired of the animal can be stored on controller (114) in association with the animal profile. In other cases, the sensor data is transmitted to the server (106) in association with an animal identifier, thereby allowing the server (106) to associate the sensor data with a particular animal profile.

To provide light for the imaging sensor subsystem (110), the stock (202) may include one or more light sources (206) mounted to various regions on the assembly frame (112).

As indicated previously, the assembly (102) can include the controller (114). Controller (114) can couple to the various system components of assembly (102), and receive data therefrom. For example, controller (114) can couple to one or more of the sensor system (110) to receive sensor data therefrom.

In some examples, the controller (114) can trigger the sensor system (110) to generate sensor data. The triggering may occur automatically, or in response to user input.

In at least one example, controller (114) can drive the sensor system (110) synchronously to capture sensor data (e.g., images) of the animal (108) in a master-slave configuration. In this case, the controller (114) acts as the master and the sensors of the sensor system (110) are triggered synchronously as the “slaves”.

For a plurality of similar cameras, e.g. RGB-D cameras, one master camera can also trigger other slave cameras synchronously. The master camera itself is triggered by the controller (114) or by a human operator.

Controller (114) can have various other functions including automatically: activating the entrance and exit door gates, activating the animal headlock system (204b), activating and controlling the sensor arms (208) to adjust the sensors' position with respect to the animal location.

Controller (114) can also control the sensor holders (208) to adjust the sensors' view angle with respect to the animal position (108). The controller (104) can be used as well for moving the sensors (110) laterally alongside the assembly frame (112), for smaller or bigger animals, and/or to adjusting the sensors' field of view.

### III. EXAMPLE METHODS

The following is a description of various example methods for implementing the disclosed example embodiments.

### (i) General Method

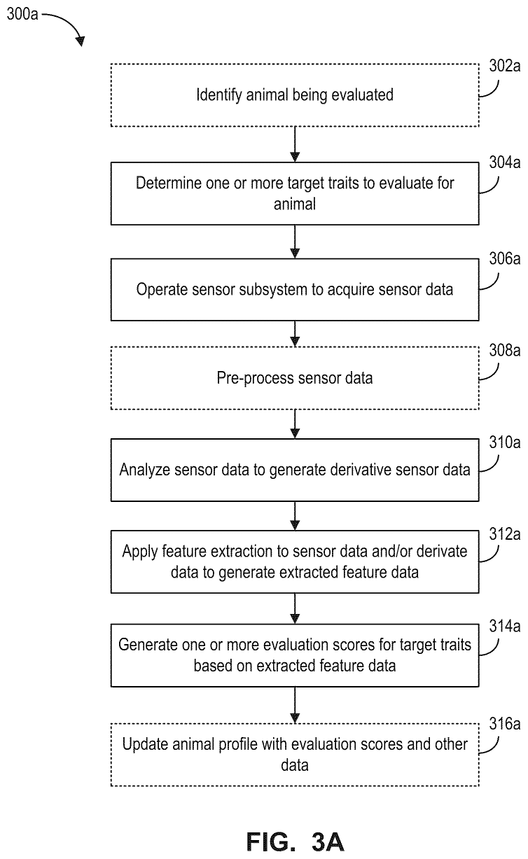

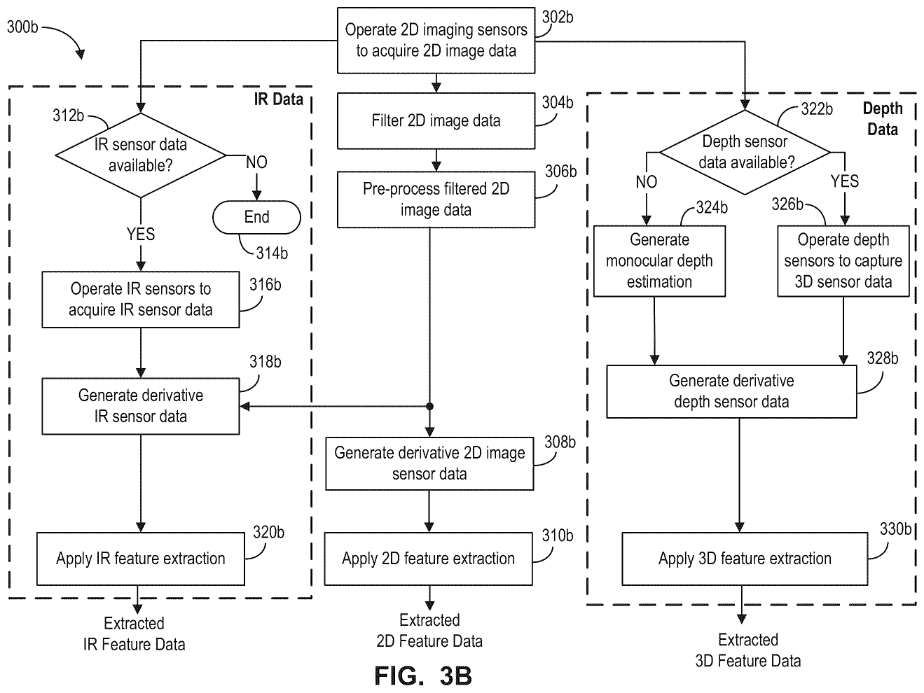

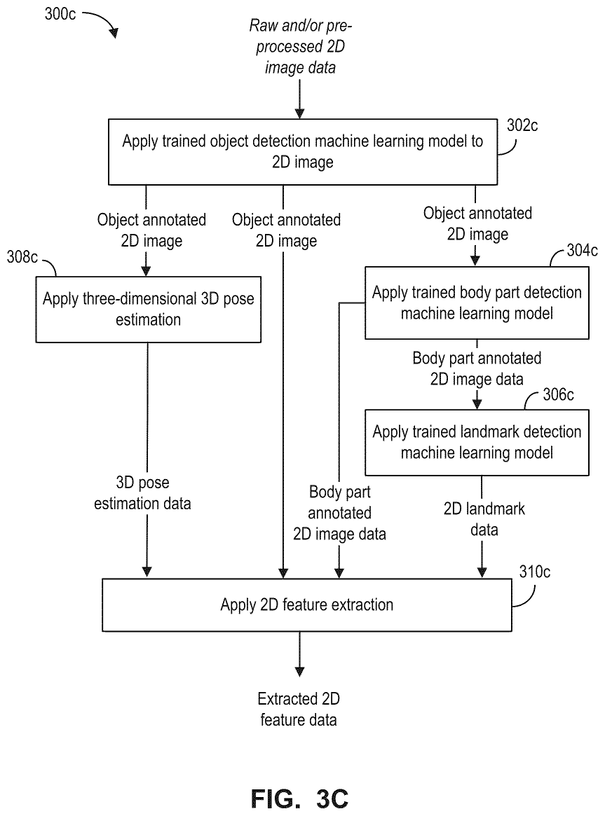

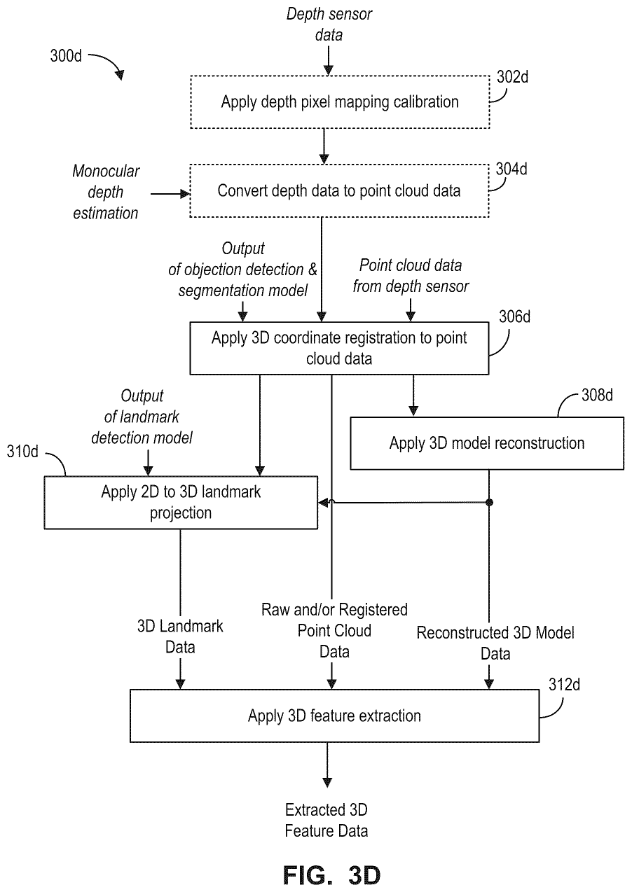

Reference is now made to FIG. 3A, which shows an example method (300a) for monitoring and evaluating animals.

Method (300a) can be performed by one or more of the automated evaluation assembly (AEA) (102) and/or user device (104a), e.g., a processor of either AEA (102) and/or user device (104a). In some cases, method (300a) is also at least partially performed by a processor of server (106).

As shown, at (302a), the system identifies the animal being evaluated. In some examples, this involves determining the type of evaluated animal (e.g., a cow or a horse). In other examples, this can further involve identifying and associating an animal profile with the animal. In the latter case, this ensures that any data acquired of the animal is associated with its respective profile.

The animal is identified, at (302a), in various manners. In some cases, an identification tag (e.g., an RFID tag) is attached to the animal. If the automated evaluation assembly (AEA) (102) is used—upon the animal entering the AEA (102), the sensor subsystem (110) scans the identification tag, e.g., via an RFID scanner. The scanning can occur automatically or through user input. The scanned identification tag can identify the animal to the system, e.g., animal type and/or the specific animal. If AEA (102) is connected to server (106), it may also communicate the identification information to the server (106), to help identify the animal.

A similar concept is applied if the user device (104a) is used for evaluation. In this case, the device's sensor subsystem can identify the tag in an image of the animal.

Other example techniques for animal identification can include, for example, visual and/or image analysis of the animal. For example, the animal can be identified via facial identification image processing techniques. An animal may also be identified by image processing of its muzzle or other parts of body, such as the patterns of spots in its body. In at least one example, the object detection model in act (302c) in FIG. 3C (as discussed herein), can also be used to classify and identify the animal. In these cases, act (302a) can be integrated with act (310a).

In some examples, act (302a) is not necessary if, for example, the system is configured to only identify a single type of animal.

At (304a), the system can further determine one or more target traits to evaluate. This can relate to one or more health-related traits, animal welfare-related traits and/or body structure-related traits.

For instance, in an example involving a cow (108), traits can relate to one or more linear composite traits. For example, it can relate to the shape, size and/or texture of different body parts (e.g., cow's body depth, udder depth, chest width, udder texture). More generally, system (100) can evaluate various desired qualitative and/or quantitative traits, as previously defined.

The target traits, to be evaluated, are determined in several manners. In some examples, the system is configured to evaluate only a fixed set of traits. For instance, if the system is only used to evaluate cows, it may be pre-configured to evaluate a pre-defined trait set for all cows.

In other examples, the target traits are dynamically determined. For example, the target traits being evaluated may vary based on the animal type. For example, after the system determines—at act (302a)—the animal type being evaluated (e.g., a cow or a horse), it may automatically evaluate a predefined set of target traits associated with that animal type. In this manner, the system can adapt to different animal types.

The target traits can also vary dynamically based on the specific animal being evaluated. That is, even among animals of the same type (e.g., cows), different animals can be evaluated for different target traits.

For example, the animal's profile—e.g., accessible via server (106)—can indicate that a specific animal should be evaluated for a specific set of traits. Otherwise, the animal's profile may indicate that a certain set of traits requires specific monitoring and evaluation, e.g., due to historically poor evaluation performance for that trait.

In other examples, the target traits vary dynamically based on the use application. For example, the system may evaluate domestic animals (e.g., livestock) for different traits than recreational animals (e.g., racing horses).

In still yet other examples, the target traits may vary based on the body part being evaluated. For example, certain traits are evaluated for a cow's mammary systems versus its foot and legs.

It is also possible that the target traits are determined via user-selectable input. For instance, using mobile application on user device (104a), the user can select a set of traits for the system to evaluate.

At (306a), the sensor subsystem is operated to acquire (e.g., capture) sensor data of the evaluated animal. This can involve operating a single sensor, or multiple sensors (e.g., one or more sensors).

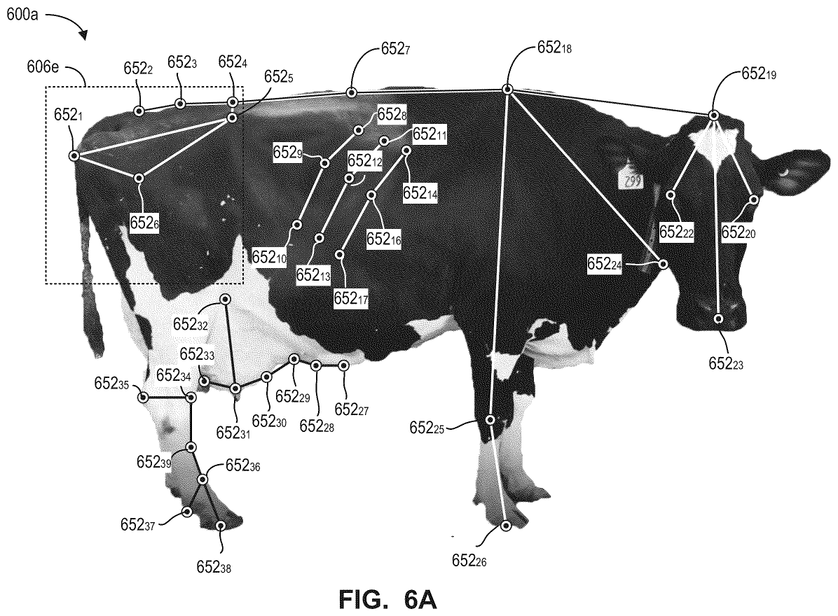

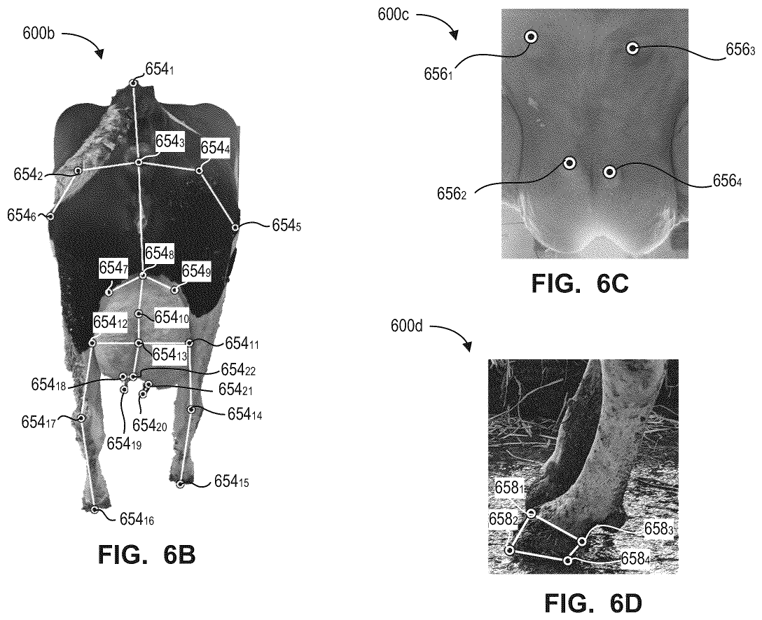

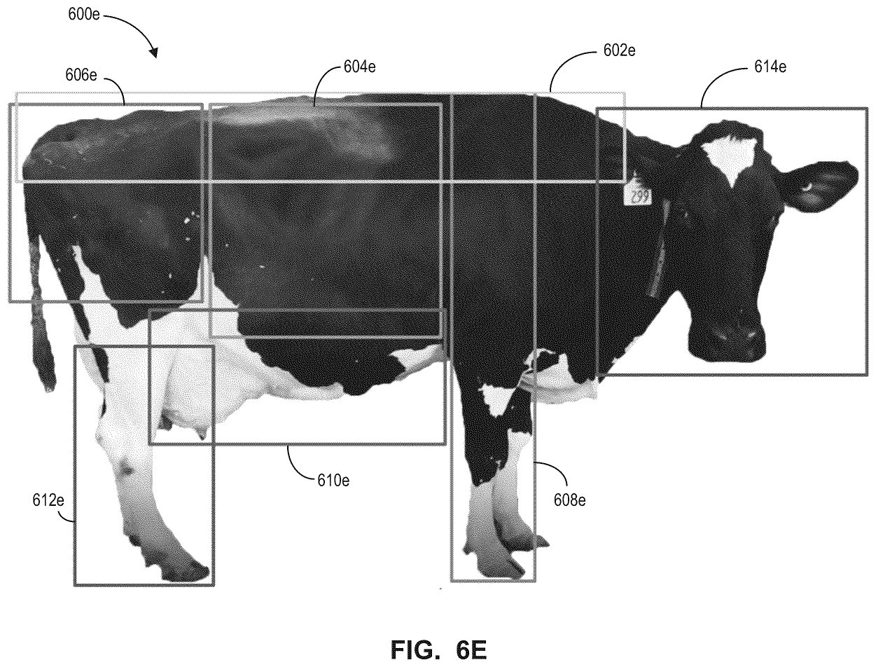

In some cases, the sensor subsystem is operated to only acquire sensor data of a particular portion of the animal. For instance, in an example involving a cow, it may only be necessary to evaluate a cow's udder (FIG. 6C) or a cow's hoof (FIG. 6D). Accordingly, it may not be required to capture sensor data of the entire animal (e.g., cow).

In examples where the automated evaluation assembly (AEA) (102) (FIG. 1) is used—act (306a) can involve operating sensors, which are part of the AEA's sensor subsystem (110). In other examples, if a user device (104a) is used (FIG. 1)—then act (306a) involves operating the user device's sensors.

Example types of sensors that can be operated at (306a) include two-dimensional imaging sensors (e.g., to capture 2D image data and/or video image frames). These can include various types of RGB cameras (e.g., monocular cameras, webcams, etc.), as well a video cameras. If multiple imaging sensors are positioned around the animal, such as in AEA (102), then the imaging sensors can be concurrently, or substantially concurrently, operated to capture multiple images of the animal (108).

Operated sensors may also include one or more depth or three-dimensional sensors, including time-of-flight cameras (e.g., LiDAR sensors), RGB-D cameras and/or structured light cameras.

In some examples, operated sensors further include infrared (IR) thermal imaging sensors. These are used to identify features that may not be visible in visible light or RGB images. Ultrasonic sensors and weight sensors may also be operated.

In examples where the user device (104a) is used for evaluation, it is possible that the same or different sensors are operated at (306a), but at different time instances. For example, a mobile application hosted on user device (104a) may guide the user to take multiple consecutive images of animal (108), and at different view angles.

Where the AEA (102) and/or user device (104a) include multiple sensors—all of the sensors may be operated at (306a). In other examples, however, only the sensors required to evaluate the target traits are operated. For example, the system may determine that only a single RGB camera—positioned at a specific view point angle in AEA (102)—is required to evaluate a certain target quantitative trait (e.g., rear leg-side view trait of cow). Accordingly, only that RGB camera is operated at (306a).

At (308a), at least some or a portion of the sensor data is pre-processed, to generate pre-processed sensor data. As explained in greater detail herein, this may involve applying various pre-processing techniques (e.g., resizing, cropping, rotating, etc.) of acquired 2D image data of the animal. This can enhance the system's ability to more accurately evaluate the target animal traits.

At (310a), the sensor data and/or pre-processed sensor data is further analyzed to generate derivative sensor data. As used herein, derivative sensor data includes any further data, generated from the raw and/or pre-processed sensor data. In some cases, derivative data is generated by combining multiple types of sensor data and/or combining sensor data generated by different sensors of the same type.

At (312a), a feature extractor is applied to one or more of the raw sensor data and/or the derivative sensor data.

The feature extractor extracts one or more features associated with the target traits. In some examples, the system stores pre-defined features that are associated with, and should be extracted for, each target trait identified at (304a). This can be stored, for example, in a database or other lookup table. The process of feature extraction is explained in greater detail with reference to FIGS. 3B and 3C.

As used herein, “trait-specific features” are features that are known to relate to evaluating a specific trait. Accordingly, at (312a), based on the target traits, the system can extract one or more associated trait-specific features. It is possible that different traits have overlapping trait-specific features.

At (314a), the extracted features (e.g., trait-specific features) are used to evaluate one or more target animal traits. This can involve, for example, determining one or more numerical scores or grades, in association with each target trait (also known as evaluation trait scores). For instance, when evaluating quantitative body structure traits for a cow, act (312a) can involve determining a score for one or more body parts (e.g., body depth, teat length, rump angle, etc.).

In at least one example, as explained herein, fuzzy logic is used to manage uncertainty and imprecision in the process of determining evaluation scores based on extracted feature data.

In some examples, the scores of individual traits can be merged to generate an overall evaluation score for a trait complex that encompasses the corresponding individual traits. The combination of individual traits' scores can either be weighted or unweighted.

For example, in the case of a cow, an evaluation score can be generated for the mammary system by using a weighted combination of the scores of various conformation traits of the mammary system, such as udder floor (tilt of the udder), udder depth, udder texture, median suspensory score (depth of cleft), fore attachment, front and rear teat placement, among other relevant scores.

The scores of different trait complexes or individual traits can be combined to generate a final score for the animal, using either a weighted or unweighted combination. For instance, in the case of a cow, a final conformation score could be calculated by combining the overall scores for trait complexes such as mammary system, feet and legs, dairy strength, and rump.

To accommodate the variations in scoring systems across countries, breeds, and animal types, in some examples, a reinforcement learning method is used. This method adjusts generated scores and map the scores to the appropriate scoring system. In turn, this provides each customer with customizable and interpretable scores.

At (316a), if the animal is associated with a profile (act (302b)), the profile is updated with the evaluated scores (e.g., numerical scores or other assessments). This allows the animal profile to be used for monitoring various animal state data over time.

The animal profiles can be stored and/or maintained, for example, on server (106). This allows the animal profiles to be accessible remotely (e.g., via internet or network) by a user device (104).

In at least one example, as previously noted, animals are associated with profiles based on an identification tag attached to the animal (e.g., an RFID tag). The identification tag can be scanned, and/or identified in captured images. Any sensor data generated in association with the animal—including any processed sensor data—can be transmitted to server (106) in association with an animal identifier, determined from the scanned tag. In this manner, server (106) can associate the data with the respective animal profile.

To that end, method (300a) can be performed entirely by the automated evaluation system (AEA) (102) and/or user device (104). In other examples, only a portion of the method (300a) is performed by AEA (102) and/or user device (104). For instance, only acts (302a) and (304a) are performed by AEA (102) and/or user device (104a). Once the images are captured, they can be transmitted, e.g., via network (105) (FIG. 1), to server (106). The remaining portion of method (300a) is then performed on the server (106).

In some examples, act (310a)-(316a) are performed based on sensor data received from both the AEA (102) and user device (104a). That is, both systems can be used in tandem to generate sensor data. The sensor data may then be coalesced at the server (106). Sensor data can also be fully and/or partially coalesced at one or more of the AEA (102) and/or user device (104a), before being transmitted to server (106).

### (ii) Analyzing Multiple Types of Sensor Data

Reference is now made to FIG. 3B, which shows an example method (300b) for pre-processing and analyzing sensor data. Method (300b) is an example of acts (308a)-(314a), in method (300a) of FIG. 3A.

More generally, method (300b) allows integrating and processing multiple sources of sensor data in order to determine target animal traits. It will be understood that the ability of the system to rely on, and combine, multiple types of sensor data allows the system to generate more accurate evaluations for complex target traits. For example, method (300b) can allow holistic evaluation of at least eighteen classification traits for a cow.

As shown, at (302b), two-dimensional (2D) imaging sensors (e.g., cameras) are operated to acquire 2D image data (e.g., analogous to act (306a) in FIG. 3A). The 2D imaging sensors can be operated manually (e.g., by a user), or automatically. To that end, the 2D imaging sensors can be associated with either the automated evaluation assembly (102) and/or user device (104a).

The 2D image data can include single image frames of the evaluated animal (or any portion thereof). In some examples, the 2D image data comprises a video, which generates a plurality of image frames.

If the system includes multiple 2D imaging sensors—then act (302b) may involve operating a plurality of 2D imaging sensors (e.g., concurrently or substantially concurrently). In this case, each 2D camera generates its own 2D image data. For example, in the automated evaluation assembly (AEA) (102), multiple cameras are positioned around the animal, and are operable concurrently to generate multiple camera-specific image data.

At (304b), a filtration process is applied to each input 2D image, generated at act (302b). Filtering involves flagging and removing images that are poor quality, or otherwise, have a quality below a pre-determined threshold. This ensures that the system relies on images with acceptable quality, in order to generate more accurate results for animal traits.

In some examples, filtering is performed using a quality control application. The application can be hosted directly on the automated evaluation assembly (AEA) (102) (e.g., on controller (114)) and/or user device (104a). In other examples, the application is hosted on server (106), which receives 2D images from assembly (102) and/or user device (104a).

Image quality control application analyzes each 2D image to determine its image quality level. This can be performed by analyzing each image based on one or more image metrics (e.g., blurriness, resolution and/or brightness).

In some examples, an individual score is generated for each image metric, and a total weighted or unweighted score is generated by combining the individual metric scores. It is then determined if the total score is above or below a threshold.

If the image quality is acceptable (e.g., above threshold), then the 2D image is retained for further analysis. Otherwise, if the image quality is poor (e.g., below threshold), then the system may require a new 2D image.

If the system requires new images, this can involve automatically operating the 2D image sensors to re-acquire images of the animal. For example, in the AEA (102), the controller (114) can automatically operate the cameras to re-acquire images. Controller (114) can also re-adjust the camera properties and/or camera position, e.g., via camera holders (208) (FIG. 2A), to capture enhanced images. This can allow controller (114) to mitigate for one or more poor image metrics (e.g., blurriness and/or brightness).

In examples where multiple cameras are used (e.g., in AEA (102))—the system may only operate the one or more cameras that captured the low quality images.

In other examples, if the image quality is poor, the system may prompt the user to retake the images. For example, the mobile application on the user device (104a) can prompt the user to re-capture specific types of images.

In still other examples, if the system has access to a plurality of image frames (e.g., in a video), the system may also select a different image frame with a higher image quality.

The image quality control application can operate in real-time, or near real-time, to analyze image quality and provide real-time, or near real-time feedback. In some cases, the image filtering step is optional.

At (306b), at least some of the raw and/or filtered 2D images—i.e., having a sufficient image quality—are pre-processed to generate pre-processed 2D images (e.g., analogous to act (308a) in FIG. 3A). The pre-processing may be performed to further enhance the image quality.

Various example image pre-processing techniques can be applied at act (306b). These include, by way of example: (i) re-sizing; (ii) cropping; and/or (iii) rotating.

Re-sizing involves modifying the image size to fit a pre-defined resolution or aspect ratio. Cropping may involve removing areas of the image to allow focus on a specific image area. This includes cropping the image to an area where the animal is expected to appear in the image.

Rotating involves modifying the orientation of the image by a set number of degrees. For example, if the image is captured by a camera which is oriented at an angle, rotation is applied to compensate for the camera rotation.

In some examples, the camera rotation may be known in advance to the system. For example, controller (114)—of the AEA (102)—may have pre-defined information regarding the orientation of each 2D imaging sensor (110). This is the case, for instance, if controller (114) controls the camera position, e.g., via arm holders (208) (FIGS. 2A-2C). Otherwise, camera rotation may be determined automatically using various image processing techniques. For example, software can be used to detect image misalignment, and can correct rotation on that basis.

Other image pre-processing techniques used at act (306b) can also include: (i) blurring (e.g., applying a blur effect to the image to reduce noise or smoothen out details); (ii) sharpening (e.g., enhancing the edges and details of the image); (iii) color conversion (e.g., changing the color space of the image, such as from RGB to grayscale or HSV); (iv) contrast adjustment (e.g., changing the difference between the lightest and darkest parts of the image); (viii) brightness adjustment (e.g., changing the overall brightness of the image); (ix) histogram equalization (e.g., adjusting the image's contrast to better distribute the intensity values); and/or (x) noise reduction and de-noising (e.g., reducing or removing unwanted noise from the image).

At (308b), derivative 2D sensor data can be generated based on the raw and/or pre-processed 2D images (e.g., analogous to act (310a) in FIG. 3A). This is explained in greater detail with respect to method (300c) in FIG. 3C.

At (310b), feature extraction is applied to one or more of: (i) the derivative 2D sensor data; (ii) the raw 2D sensor data; and (iii) the pre-processed 2D sensor data. In turn, this generates extracted 2D feature data. As explained herein, the type of features extracted can vary based on the target animal trait being evaluated. That is, the system can extract trait-specific 2D features associated with the target traits identified at act (304a) (FIG. 3A).

Returning to act (302b), in some examples, the method can also proceed to act (312b), to determine if any IR sensor data is available. If this is the case, the system may also analyze IR sensor data captured of the animal.

In some examples, the determination at act (302b) is based on the system's pre-determined knowledge of which sensors are available in the automated evaluation assembly (102) and/or user device (140a). For example, the controller (114) of assembly (102), or a memory of the user device (104a), can store information about what sensors are equipped and/or active.

If no IR sensors are available, this portion of the method (300b) may simply terminate at (314b). Otherwise, at (316b), the IR sensors are operated to capture IR sensor data (e.g., analogous to act (306a) in FIG. 3A). IR sensor or thermal data can be useful to identify animal features that are not visible under visible light, or using RGB image sensors. For example, IR sensor data can be used to detect target animal traits relating, for example, to heat stress, illness, pregnancy diagnosis, and animal welfare.

In at least one example, the IR sensors are operated concurrently, or substantially concurrently, with the 2D image sensors (act (302b)). This ensures that the sensors are all capturing the same data of the animal, during the same timeframe (or time instance). As explained next, concurrent operation of the IR and imaging sensors also allows mapping of the IR sensor data to the 2D image data.

At (318b), derivative IR sensor data can be generated (e.g., analogous to act (310a) in FIG. 3A).

In at least one example, the derivative IR sensor data comprises IR pixel mapping calibration. That is, one or more pixels in the captured 2D images (302b), are associated, or mapped to corresponding IR data. For example, image pixels of different parts of a cow's body are associated with corresponding IR data for those body parts. As explained herein, this allows evaluating different traits of the cow based on combined RGB and IR data.

The mapping, at act (318b), can be performed on the raw, filtered and/or pre-processed 2D image data. For this reason FIG. 3B illustrates an arrow from (306b) to (318b).

In at least one example, mapping between the RGB image and IR data is performed using interpolation or geometric transformation. The interpolation or geometric transformation relates the coordinates of a point in the RGB image to its corresponding coordinates in the IR image. This allows accurate IR information to be associated with each pixel in the RGB image, allowing for the fusion of the RGB and IR images into a single augmented image that preserves the information from both modalities.

More generally, due to the differences in the camera's hardware and lens characteristics (e.g., field of view of the 2D RGB and IR cameras), the RGB and IR images can have different resolutions and distortions. Accordingly, the IR pixel mapping bridges between the two mediums.

The IR pixel mapping calibration can be applied to each 2D image generated by IR sensors. For example, if the automated evaluation assembly (AEA) (102) generates a plurality of 2D IR images at the same time instance from different angles—the IR pixel mapping calibration can be applied to each 2D image. The mapping can be based on IR data from a single IR sensor or multiple IR sensors.

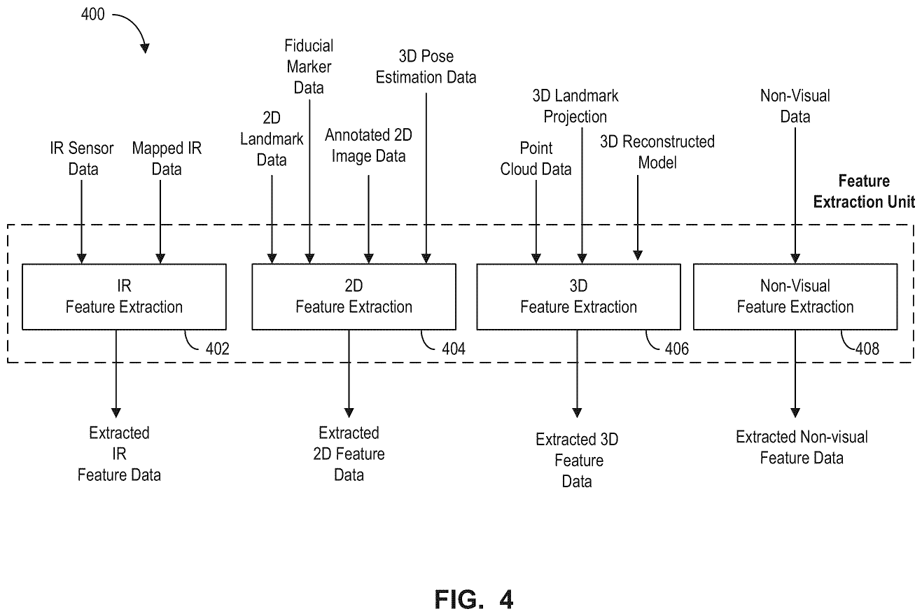

At (320b), a feature extractor is used to extract IR feature data. As shown in FIG. 4, the IR feature extractor (402) can receive inputs comprising the raw IR sensor data, as well as the derivative IR sensor data (e.g., IR pixel mapped data).

In some examples, the IR feature extractor analyzes the IR and temperature data to extract and identify patterns, shapes, or other features that are associated with the target traits being evaluated (e.g., animal heat levels, stress, etc.), as identified at act (304a) (e.g., trait-specific IR features). Features can be extracted using various methods, such statistical analysis, edge detection, texture analysis, and machine learning algorithms.

As shown in FIG. 3C, the IR feature extractor can also receive landmarks detected on an animal (e.g., body part locations) (see FIG. 3C). The landmarks are associated and combined with IR data (i.e., based on the IR pixel mapping calibration). In turn, this allows extracting temperature and heat data for specific landmarks relevant to evaluating certain target traits.

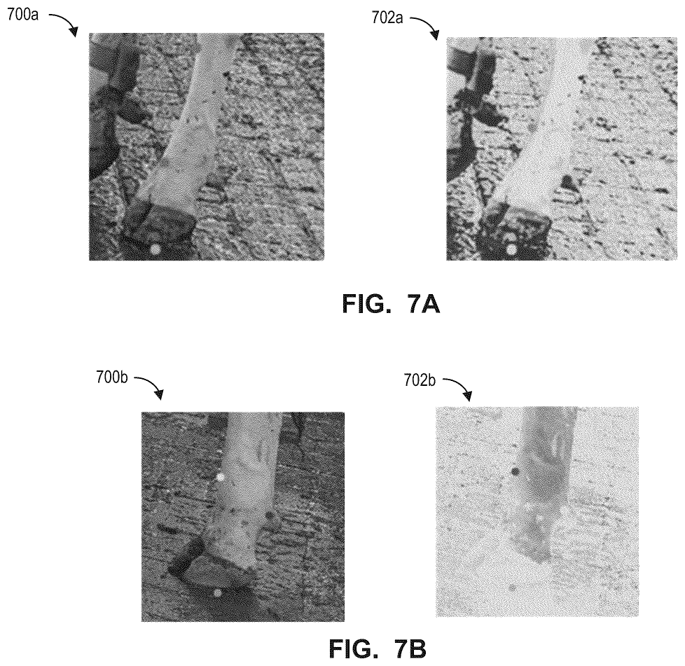

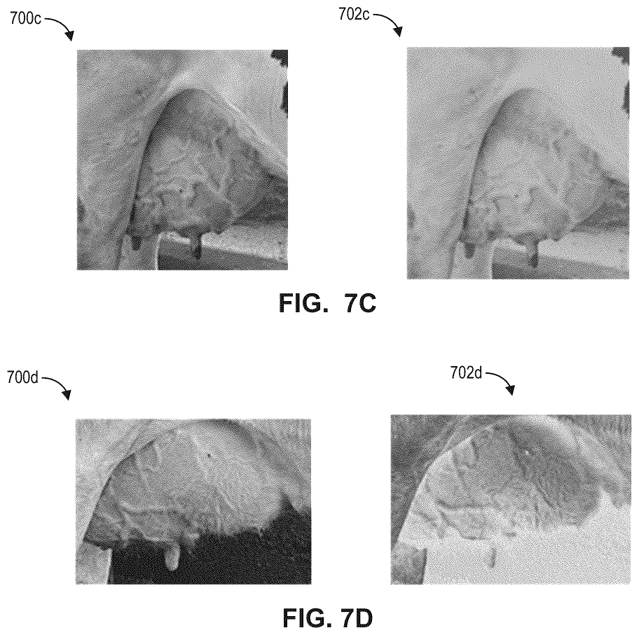

FIGS. 7A-7D show example traits that can be determined based on extracted IR feature data.

In FIG. 7A, the RGB image (700a) and mapped IR image (702a) show a healthy hoof and leg. However, in FIG. 7B, the RGB image (700b) and mapped IR image (702b) show an animal with a lame leg condition. This is because the IR mapped image (702b) shows abnormal extracted high temperature features relative to a normal IR mapped image (702a), hence demonstrating symptoms of a lameness trait.

In FIG. 7C, the RGB image (700c) and mapped IR image (702c) show a healthy udder. In particular, the IR image (702c) does not show any abnormal high temperature, and therefore no symptoms of mastitis/infection in the animal. In contrast, in FIG. 7D, the RGB image (700d) and mapped IR image (702d) show an animal that is subject to symptoms of mastitis/infection. This is because the IR image shows abnormal high temperature, and therefore symptoms of mastitis/infection.

In this manner, the IR data can detect abnormal temperatures in the animal body, which can be used to monitor and evaluate animal health traits.

Returning again to act (302b) (FIG. 3B), in some examples, the system can also determine if one or more depth sensors (e.g., 3D sensors) are available, at act (322b). Similar to act (312b), this determination can also be based on pre-determined knowledge of which sensors are available, e.g., in AEA (102) and/or user device (104a).

If depth sensors are included, then at (326b), the depth sensors are operated to acquire depth sensor data, e.g., 3D sensor data (e.g., analogous to act (302b) in FIG. 3A). The depth sensors can be operated concurrently, or substantially concurrently, with the 2D image sensors. As explained, this allows mapping the depth data to the RGB image data.

At (328b), derivative 3D sensor data is generated based on the depth sensor data. This is explained in greater detail, with respect to method (300d) of FIG. 3D.

In other examples, where depth sensors are not available—at act (324b), 3D data may be generated based on monocular depth estimation. This allows the reconstruction of a 3D model of the animal from the 2D images or videos (302b)-(306b). It is also possible for monocular depth estimation to be performed, even if depth sensors are available, e.g., as an additional source of depth data.

More generally, the monocular depth estimation estimates the depth or distance of objects from camera using a single 2D RGB image. Deep learning-based algorithms can be applied to predict the depth map of a scene from pre-defined 2D image features (e.g., edges, textures, and color gradients of the 2D image).

In at least one example, to enable monocular depth estimation—a UNet-based model is trained using a supervised learning approach on large datasets of images with known ground-truth depth information (e.g., RGB-D datasets) to generalize the relationship between 2D image features and depth information. In the input, a 2D image is provided, where the model learns to minimize the difference between its predicted depth maps and the ground-truth depth maps.

As shown, the output of the monocular depth estimation can also be used to generate derivative 3D data (328b).

At (328b), a feature extractor is applied to extract features from the raw and/or derivative 3D data, and to generate extracted 3D feature data. The types of extracted 3D feature data are provided in greater detail herein. In some examples, the extracted features are trait-specific 3D features, associated with the target traits being evaluated.

While not shown, if other sensors are available (e.g., ultrasonic sensors, weight sensors), a similar decision tree as acts (312b)-(320b) can be applied for those sensors.

More generally, method (300b) can repeat at any pre-defined time interval or frequency. For example, at each new time instance where 2D image data and/or IR sensor data and/or depth sensor data are captured (e.g., concurrently captured) —method (300b) can be applied to generate corresponding raw, derived and/or extracted feature data.

### (iii) Generating Derivative 2D Image Sensor Data

Reference is now made to FIG. 3C, which shows an example method (300c) for generating derivative 2D image sensor data, based on 2D image data. Method (300c) corresponds to act (308b), in FIG. 3B, and can be applied to each individual 2D image being analyzed.

In some examples, method (300c) is performed by a processor of one or more of servers (106), automated evaluation assembly (AEA) (102) and user device (104a).

As shown, a 2D image is accessed. For example, this can be a raw 2D image and/or a pre-processed 2D image, e.g., act (306b) in FIG. 3B.

At (302c), the 2D image is processed using a trained object detection machine learning model. The model identifies the location of various target objects within the image frame.

In more detail, the object detection model is trained to identify and/or classify the image area (e.g., pixel region), corresponding to the animal being evaluated. In some examples, the output of the model is an object annotated 2D image, with an annotation (e.g., bounding box), or other indicia, identifying the location of the detected animal. The output can also classify the type of detected animal.

In some examples, the trained model generates a confidence score for each detected instance of an animal in the image. The instance with the highest score is then selected as the detected animal.

In some examples, the object detection model is trained to detect non-animal objects. For example, it is possible that a reference object of a known size, is placed in the surrounding environment to provide a sense of scale, in the image. This can include a fiducial marker (e.g., ArUco marker). The object detection model can accordingly detect and classify the marker.

To that end, the detected marker can be used to estimate the distance between any two points in the image based on the known size of the marker and the number of pixels of the marker image. This can be used to determine the distance between different points on the animal body, e.g., to measure certain quantitative target animal traits, such as conformation and body-structure traits. This is especially useful if there are no depth sensors available.

More generally, the object detection model can be trained on a training set of 2D images, which are pre-annotated (or pre-labelled) with the locations and types of target animals, as well as other target objects in the image (e.g., fiducial markers). In respect of detecting animals, the object detection model can be trained to identify a single type of animal, or multiple types of animals, e.g., depending on the use case.

If the object detection model receives an image of a portion of an animal (e.g., a hoof or hip, etc.), it may only identify that portion as corresponding to the animal.

In at least one example, act (302c) can also involve applying a trained segmentation machine learning model, after the object detection model is applied. The segmentation model applies a pixel-level mask for each detected object (e.g., animal) to segment the foreground object (e.g., animal) from its background in the 2D image. Semantic segmentation can assign each pixel in the image to a specific class, e.g., “foreground animal” or “background”.

The segmentation model can be used to enhance the accuracy of the system, as it focuses the output annotated image on the target objects of interest. Any subsequent steps or blocks that use the output annotated image are then more likely to use it more effectively.

In some examples, the segmentation model generates a mask that delineates the segmented foreground object (e.g., animal), along with the confidence score indicating the accuracy of the segmentation for that object (e.g., animal) in the given image.

The combined object and segmentation model can use a convolutional neural network (CNN) or any other type of deep neural network architecture such as Mask R-CNN and HRNet, to learn the mapping between the input 2D image and the corresponding segmentation map. The model may be trained on a dataset of labeled images or videos, where each image or video has an associated foreground object mask (e.g., animal), to learn the features that are relevant for foreground object (e.g., animal) segmentation.

In the case of an image containing multiple animals or different types of animals—the combined object detection and segmentation model may also be trained to detect the type of animal in each segment. For example, the model may be trained to perform classification to predict the class of each object or animal. The model can then select the largest foreground animal in the image that belongs to the intended animal type as the target animal.

The output of the object detection (and, in some cases, segmentation model) (302c) can be fed to one or more of: (i) a 2D feature extractor (310c); (ii) a body part detection model (304c); and/or (iii) a 3D pose estimator (308c).

The output of (302c) can be an object annotated 2D image, with an annotation (or other indicia, such as pixel coordinates) of the location of the animal in the image (e.g., a bounding box). In some examples, the object annotated image can also include a classification of the detected animal, and/or an indication of a confidence score of the detected animal. The object annotated image can also include an annotation, or other indicia, of any target non-animal objects (e.g., fiducial markers).

If the segmentation model is also applied, then the output object annotated image further includes an indication of the foreground detected object(s) separated from the background. In some examples, the output image includes one or more mask delineating the foreground detected object(s).

At (304c), a trained body part detection machine learning model can also be applied to the 2D image. The model is used to identify different body parts of the imaged animal. That is, the model can divide the 2D image into separate regions or segments corresponding to different body parts. Each of these regions may be marked by an indicia or annotation (e.g., a bounding box) that represents the corresponding body part, and in some examples, provides a classification of the body part. A confidence score associated with each annotation can indicate the accuracy of the segmentation.

In at least one example, the body part detection model utilizes a deep learning-based model. For example, this includes YOLO object detection models such as YOLOv5 and YOLOv8, and that have been trained on a large dataset of annotated images to recognize and segment different body parts in a 2D image of an animal.

In some examples, separate body part detection machine learning models are trained for different animal types. Accordingly, after the animal type is identified (e.g., act (302a) in FIG. 3A), one or more associated trained body part detection models are applied to that animal.

The output of (304c) can comprise a body part annotated 2D image. This image is annotated with the location of the animal in the image, as well as different classified body parts (e.g., via bounding boxes). This is shown, for example, in body part annotated 2D image (600e) (FIG. 6E), e.g., showing body parts identified by annotations (602e)-(614e). The body part annotated 2D image can be fed to a 2D feature extractor (310c). The image can also be fed to a landmark detection model, at act (306c).

At (306c), one or more trained landmark detection machine learning models are applied to the body part annotated 2D image.

More generally, the trained landmark detection model(s) can identify specific landmarks on an image of an animal. As used herein, a body landmark is a specific anatomical point or feature on an animal's body that can be used as a reference for measuring or assessing other features or traits. Examples of body landmarks in animals include the withers in horses, the shoulders in dogs, or the hip bones in cows.

To that end, FIGS. 6A-6D shows various example detected landmarks on an example image of a cow, including: (i) landmarks (652₁)-(652₃₉) detected on a side view image (600a) of the cow, (ii) landmarks (655₁)-(652₂₂) detected on a rear view image (600b) of the cow, (iii) landmarks (656₁)-(656₄) detected on an image (600d) of the bottom view of the cow's udder, and (iv) landmarks (658₁)-(658₄) detected on an image (600d) of the cow's hoof.

In respect of the 2D landmark data, this data can be fed to the 2D feature extractor to determine various quantitative traits for an animal (e.g., animal's height, length, or other body structure dimensions), as well as to assess the animal's posture and movement.

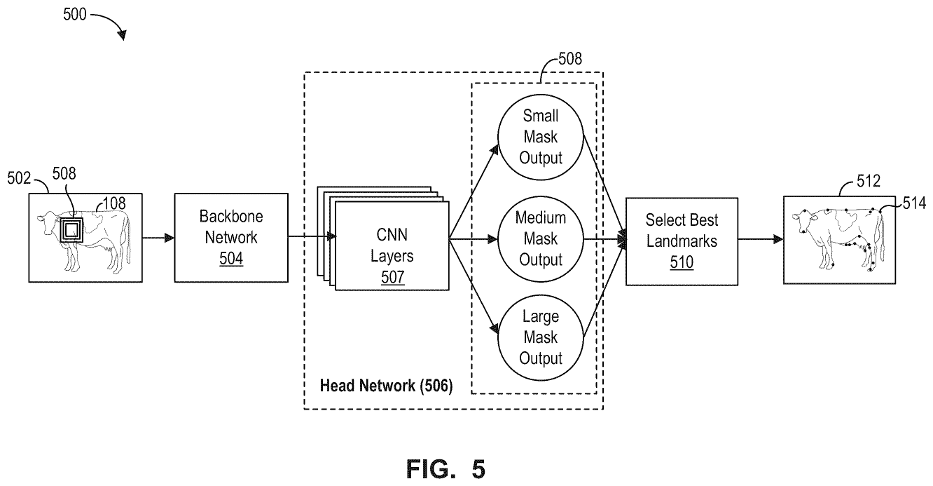

The landmark detection model(s) can be implemented in various manners. In at least one example, the landmark detection model(s) are based on deep-learning based landmark detection methods. For example, this can include using DeepLabCut, OpenPose, and MMpose network. These networks can be trained to detect landmarks associated with different body parts, and animal types. As explained in further detail herein, the architecture (500) of FIG. 5 can be used for landmark detection.

It will be understood that operation of the landmark detection model(s) are facilitated by the object detection model (302c) (and/or the animal identification at act (302a) in FIG. 3A).

For example, the landmark detection models can be trained to identify landmarks specific to certain animals (e.g., “animal-specific landmark detection model”). In some examples, there may be multiple trained models for different animal types (e.g., cows, horses, etc.). Therefore, depending on the animal classification by the object detection model, a corresponding animal-specific landmark detection model is applied to the object and/or body part annotated 2D image.

In addition, or in the alternative, the landmark detection model(s) are facilitated by the output of the body part detection model (304c). That is, the body part detection model can detect different body parts. In turn, the landmark model(s) can analyze the different body parts for different body-part specific landmarks.

In some examples, as shown in FIG. 6E, each detected body part (602e)-(614e) is cropped to generate a sub-image, showing only that body part. Each body part sub-image is then fed independently into the trained landmark detection model. The landmark model can also receive an input indication of which body part the sub-image corresponds to. The landmark model can then detect body part-specific landmarks, specifically associated with that body part. This can enhance the predictive accuracy of the model.

To further clarify, as shown in FIG. 6E, a cow's hip body part (606e) can be cropped and fed individually into the landmark detection model. In turn, the landmark model can identify hip-specific landmarks. For example, in FIG. 6A, the hip-specific landmarks correspond to landmarks (652₁)-(652₆). Similarly, in FIG. 6C, the landmark detection model detects udder-specific landmarks (656₁)-(656₄). In FIG. 6D, the landmark detection model detects hoof-specific landmarks (658ₑ)-(658₄).

In at least one example, separate landmark detection models are provided for each body part. Each separate landmark model is specifically trained to detect body-part specific landmarks for corresponding body parts (also referred to as “body part-specific landmark detection models”).

In these examples, each body part cropped by its corresponding bounding box is fed to its associated body part-specific landmark detection model, depending on the classification of that body part (e.g., by body part detection model (304c)). This can also be performed to further enhance the predictive accuracy of the landmark detection.

In these examples, it is understood that the landmark models can include a combination of: (i) trained animal-specific landmark detection models, wherein (ii) each animal-specific landmark detection model itself includes one or more trained body part-specific models for that animal.

In other examples, rather than feeding only cropped body part images to landmark detection models—the entire image of the animal (or any portion thereof) (FIG. 6E) is fed directly into the landmark detection model(s).

For example, the entire image in FIG. 6E is fed into the landmark detection model. This is preformed if, for instance, only a few landmarks require detection. This includes cases where an image of a small animal, with only a few necessary landmarks, is being analyzed. This also includes cases where the system analyzes images of only a portion of the animal, rather than the entire animal (e.g., therefore, only a few landmarks need detection).

At (308c), a 3D pose estimator may be applied to the output of the object detection model, e.g., the object annotated 2D image.

In more detail, evaluation errors can occur when assessing animal traits or measurements from images or videos captured from a single viewpoint, due to a perspective effect. This can result in inaccuracies in evaluations as the perspective can alter the animal's actual size and shape.

Accordingly, to mitigate the perspective effect, it may be desirable to adjust for perspective distortion. The 3D pose estimation can infer the 3D location and orientation of the animal in 3D space relative to the camera that captured its image. This 3D pose information can be used for perspective effect mitigation during extraction of 2D features, by the 2D feature extractor (310c).

The 3D pose estimation can employ various methods for monocular pose estimation. These include, for example, perspective-n-point (PnP) algorithms including EPnP, UPnP, and APnP, as well as deep learning-based pose estimation methods such as PoseNet, DeepPose, and MultiPoseNet. These methods estimate the 3D pose of an animal from a single camera view by predicting the pose from 2D image features.

In other examples, the 3D pose estimation (308c) can use the Structure from Motion (SfM) method to estimate the 3D pose of an animal. This is performed by tracking feature points or salient points in multiple frames to determine the animal's motion. This motion information can then be used to reconstruct the 3D pose of the animal.

At (310c), one or more 2D feature extractors are applied. In some examples, this includes a (i) 2D quantitative feature extractor; and (ii) 2D qualitative feature extractor. In some examples, these extractors generate trait-specific 2D features.

With respect to (i), the 2D quantitative feature extractor can employ a subset of the detected 2D landmark data, on 2D images, to measure various body part specific properties (e.g., distance, angle, or relative position). This can be used for determining various quantitative target animal traits, e.g., used for identification, evaluating body structure, health and welfare properties.

It is understood that, for the purposes of 2D quantitative features, the feature extractor can combine the 2D landmark data, with the annotated images generated from each of the object detection model (302c), and the body part detection model (304c).

For example, the body part detection model (304c) can localize different body parts, relative to 2D landmarks. This can allow determining which body parts, and which associated landmarks, are associated with which quantitative features. This is shown, by way of example, in body-part annotated image (600e) (FIG. 6E). As shown, each of the annotated body part sections (602e)-(614e) can be used by the 2D landmark detection to facilitate detection of body part-specific landmarks.

FIGS. 6A-6D show example features that can be extracted, from the 2D landmarks on a cow, to generate cow trait evaluation scores (e.g., act (314a) in FIG. 3A). These include, for example:
Rear Legs Side View Trait Score: Based on an extracted angle feature, which is measured at the front of the cow's hock, e.g., angle made by landmarks (652₃₄), (65239), and (652₃₆) (FIG. 6A).
Udder Depth Trait Score: Relational distance position of landmarks (652₃₁) and (652₃₅) (FIG. 6A).
Rump Angle Trait Score: The height of landmark (652₁) relative to height of hip bone landmark (652₅) e.g., measured in centimeters (FIG. 6A).
Stature Trait Score: The height of top of the spine in between hips (652₄) to ground.
Pin Width Trait: Distance between landmarks (654₂) and (654₄) (FIG. 6B).
Front Teat Placement and Rear Teat Placement Trait Scores: The front teat placement is determined by the position of the front teat landmarks (656₁) and (656₃) (FIG. 6C) from center of quarter. Rear teat placement is determined by the position of the rear teat landmarks (656₂) and (656₄) (FIG. 6C) from center of quarter.
Foot Angle Trait Score: Angle of hairline on the hoof (e.g., the line segment between landmarks (658₁) and (658₃), to floor (FIG. 6D).

In some examples, with respect to dairy cows, the system is able to generate scores for at least eighteen conformation traits (including a mix of quantitative and qualitative traits). This is owing to the wide array of sensor data being acquired and processed.

As noted previously, in some embodiments, a reference object of a known size may be imaged (e.g., fiducial markers), and is used for the distance estimation, e.g., between landmarks for quantitative feature extraction. The marker may be detected by the object detection model (302c). The pixel/mm ratio of the marker can be determined by dividing the known size of the marker (e.g., in millimeters) by its size in pixels in the image. This ratio can be used to estimate the distance between two landmarks in the image based on the number of pixels between them.

As explained above, at (310c), the 2D feature extractors includes (i) the 2D quantitative feature extractor (discussed above); and (ii) the 2D qualitative feature extractor.

With respect to (ii), the 2D qualitative feature extraction can employ a combination of classic image processing techniques, and end-to-end solutions, such as deep neural networks, to establish a direct mapping between the image and the corresponding score for evaluating different qualitative animal-specific traits. The utilized approach may vary depending on the trait being evaluated.

In some examples, complex traits may require a combination of both quantitative and qualitative feature extraction methods in order to fully capture and evaluate all aspects of the trait. For example, an angularity score for dairy cows may require evaluating various quantitative and qualitative cow traits, such as the angle, openness, and spring of the cow's ribs.

As explained previously, fuzzy logic can be used to process extracted features to generate evaluation scores (e.g., act (314a) in FIG. 3A). For example, in the example case of extracted 2D features, the system utilizes appropriate linguistic variables and rules to assign scores to different features of the animal landmark, such as the angle between landmarks, the relational position of multiple landmarks, and the overall structure of the landmarks.

In addition to landmarks, image features such as color, texture, and shape of the animal can be used to improve the accuracy of evaluation scoring based on extracted 2D feature data. Rules for the shape of the animal body can be derived from image features in addition to rules for landmarks. The system can be tailored to fit the specific needs of different applications, and the scoring rules can be updated based on specific requirements using reinforcement learning.

### (iv) Generating 3D Derivative Sensor Data

Reference is now made to FIG. 3D, which shows an example method (300d) for generating 3D derivative sensor data. Method (300d) corresponds to act (328b), in FIG. 3B.

In some examples, method (300d) is performed by a processor of one or more of servers (106), automated evaluation assembly (102), and user device (104a).

At (302d), if depth sensor data is acquired (e.g., captured), depth pixel mapping calibration can be applied to acquired depth sensor data. This is used to map depth sensor data to the captured 2D image data.

In particular, 2D/RGB and depth images captured, e.g., by an RGB-D camera, can have different resolutions and distortions due to the camera's hardware and lens characteristics such as field of view (FOV). Accordingly, pixel mapping calibration can generate an accurate mapping between the pixels in the 2D/RGB and depth images by applying corrections.

The depth pixel mapping calibration can perform mapping by using interpolation and/or geometric transformation that relates the coordinates of a point in the 2D image to its corresponding coordinates in the depth sensor data. This enables the depth sensor data to be associated with each pixel in the 2D image, allowing for 3D reconstruction and other applications.

At (304d), in some examples, depth map data can be converted into point cloud data. For example, data generated by a 3D sensor (e.g., time-of-flight (ToF) sensor) can be converted into point cloud data.

The depth map to point cloud converter can map each depth value to a corresponding 3D point in space. This can be performed by using the intrinsic and extrinsic camera parameters to transform the pixel coordinates into 3D world coordinates. The point cloud data can be generated based on depth sensor data generated directly by a 3D depths sensor (326b) (FIG. 3B).

In some cases, act (304d) may not be required. For example, some depth sensors (e.g., RGB-D cameras) can automatically generate point cloud data. In these cases, point cloud data is ready available, directly from the depth sensor.

In some examples, act (304d) is applied to convert monocular depth estimation data into point cloud data. As noted previously, monocular depth estimation (324b in FIG. 3B) can be used if depth sensor data is not available. Additionally, it may also be useful if using a conventional reference object or marker of a known size in the image (e.g., a fiducial marker), for distance estimation, may be impractical or otherwise non-useful due to differences in the distances of the points of interest and/or the marker/object from the camera. In still other examples, monocular depth estimation can be used in addition to (e.g., as a supplement), to depth sensor data. In more detail, the depth map to point cloud converter can take the depth value of each pixel (e.g., in units of meters) as input. An intrinsic camera matrix can then be applied to the pixel coordinates to obtain the corresponding 3D coordinates in the camera's coordinate system. An extrinsic camera matrix can then be applied to transform the camera coordinates into world coordinates. Each 3D coordinate is then assigned its corresponding depth value, resulting in a point cloud.

At (304d), 3D coordinate registration can be applied, using point cloud data.

In some embodiments, multiple 2D/RGB-D cameras are installed on the automated evaluation assembly AEA (102), each capturing a partial part of the animal body. Accordingly, if a 3D model of the entire animal's body is required, the 3D coordinate registration can align and merge the partial point clouds generated by multiple cameras, allowing for the creation of a single, coherent 3D model of the animal. This allows determining the relative position and orientation of each camera with respect to a common coordinate system, so that the point clouds can be accurately aligned and merged.

In at least one embodiment, if the location of the cameras installed on the AEA (102) are fixed and known, the 3D coordinate registration can utilize the relative position of cameras to compute the transformation matrix that maps the points in one camera's coordinate system to the common coordinate system.

If the location of the cameras installed on the automated evaluation assembly (102) are not calibrated, or if the camera holder arms (208) move during the automation process to adjust the cameras' position and view angle with respect to the animal, the relative position of the cameras is not known and can be computed by the 3D coordinate registration.

In at least one example, a fiducial marker (e.g., ArUco marker) can be used for 3D coordinate registration. For example, as explained, a fiducial marker may be placed in a fixed location in front of each camera on the stock (202), and its image captured by the 2D and/or RGB-D camera. The 3D coordinate registration applies a pose detection technique (e.g., Perspective-n-Point (PnP) algorithm), to estimate the marker's position and orientation in 3D space for each camera.

To that end, the preliminary calibrated position and orientation of the camera relative to the fiducial marker may be known, allowing the system to accurately determine the current position and orientation of the camera in 3D space. Any deviation from this calibrated relative position and orientation can be used to estimate the camera's current position and orientation in relation to the marker and in 3D space. This information is then used to adjust the transformation matrix to align the partial point clouds generated by each camera into a single, coherent 3D model of the animal.

At (308d) and (310d), the output of the 3D coordinate registration can be applied for both 3D model reconstruction (308d) and/or 2D to 3D landmark projection (310d).

With respect to act (308d), the 3D model reconstruction can use various mathematical algorithms and techniques (e.g., missing area correction, surface reconstruction, meshing, and texturing) to convert the point cloud data obtained from the animal's body or a specific body part into a digital 3D model.

In at least one example, the 3D model reconstruction (308d) removes unwanted data and the background from the point cloud to generate a cleaner and more precise 3D model of the animal. This can be achieved using various techniques, including clustering, 3D segmentation, plane fitting, and depth thresholding, either individually or in combination, depending on the characteristics of the point cloud and the level of background removal needed.

In some embodiments, where the stock (202)—of automated evaluation assembly (102)—is fixed and results in a fixed background in the images: the 3D model reconstruction can reconstruct a 3D model of the background scene in the absence of the animal. This allows removing the 3D model of the background from the reconstructed model when the animal is present in the stock (202), resulting in a cleaner and more accurate 3D model of the animal.

In at least one example, the background removal can be achieved through segmentation in the depth map and 3D model reconstruction using the segmented depth map. In this case, the depth map image from (302d) and/or (306d) is mapped pixel by pixel to its corresponding 2D image. The object detection and segmentation (302c) can then segment the animal in the corresponding 2D image and highlight it with a foreground animal mask. This mask can be applied to the depth map image to segment the animal and remove pixels outside the mask, effectively removing the background in the depth map image.

In some cases, a 3D model reconstruction of a cow can be used for scoring of some qualitative conformation traits such as Body Condition Score, Bone Quality (flatness of bones of rear legs), and Dairy Capacity (related to the angle, openness and spring of ribs). The 3D model of the animal can also be used for evaluating structural disorder traits, such as lameness.

More generally, the 3D model and detected body parts can also be used to determine other animal traits, such as carcass weight or composition, including percentages of bone, fat, and meat. Additionally, the 3D model can be used to predict an animal's weight at a later time of their life, such as a calf's weight at the time of breeding or a cow's mature weight, enabling better diet/management and breeding planning. With additional devices, such as ultrasound, the 3D model can also be used for pregnancy detection.

At (310d), 2D to 3D landmark projection can also be applied. In some applications, such as conformation trait scoring, where quantitative traits like distances need to be measured on the 3D structure of an animal's body, having landmarks on the 3D model is helpful.

The 2D to 3D landmark projection can project the landmarks detected by the landmark detection (306c) in the 2D image onto the 3D model. This enables accurate measurement and analysis of the animal's physical features. For example, in FIGS. 6A and 6B: converting the 2D landmarks into 3D landmarks allows measuring the distance between the landmarks in the 3D space for measurement-based traits such as stature, body depth, pin width, and rump angle.

In at least one example, the 2D to 3D landmark projection maps the detected landmarks on the 2D image, onto the matching pixels on the corresponding depth map. Since there is a one-to-one mapping between the pixels of the depth map and the corresponding points in the point cloud, the pixels on the depth map that correspond to the location of the landmarks can be mapped to the point cloud, representing the 3D projection of the landmarks. Similarly, the landmarks can be mapped to the reconstructed 3D model of the animal.

At (312d), a 3D extractor can be used. The 3D features of the animal's body can be used to evaluate various traits, and corresponding evaluation scores (e.g., trait scores), related to the animal's body structure and conformation, such as body condition score, body length, height at withers, chest width, and pin-width. These traits can be important indicators of animal health, productivity, and welfare.

In some embodiments, the 3D feature extraction can extract the 3D features of the animal's body by using various techniques such as:
(i) Point Cloud Analysis—Processing the 3D coordinates of the points that make up the surface of the animal's body.
(ii) Surface Curvature—Identifying the curvatures of different parts of the surface of the 3D model, which can provide insights into the animal's body shape and conformation.
(iii) Shape Analysis—Comparing the 3D shape of the animal with predefined templates or reference shapes or 3D model of an ideal animal to quantify various aspects of its conformation.

In some examples, where using a reference object or marker of a known size in the image for distance estimation (e.g., fiducial marker) is impractical or not useful, the distance between the projected landmarks on the 3D model of the animal, obtained from the 2D to 3D landmark projection (310d) can be calculated to evaluate distance-based quantitative traits.

### IV. ALTERNATIVE AND/OR SPECIFIC EXAMPLES

The following is a discussion of various alternative and/or specific examples of the above described embodiments.

### (i) Feature Extraction

FIG. 4 shows an illustration (400) of example features that can be extracted and fed to various feature extractors.

As shown, the IR feature extraction (402) can receive IR sensor data and/or IR pixel mapped data.

Two-dimensional (2D) feature extraction (404) can receive 2D landmark data, fiducial marker data (if included in the 2D image), annotated 2D image data (e.g., animal and body-part annotated data), and/or pose estimation data.

Three-dimensional (3D) feature extraction (406) can receive point cloud data, 3D landmark projection data, and/or 3D reconstruction model data.

Non-visual feature extraction (408) can receive various other sensor data (e.g., ultrasound, weight, etc.).

As indicated above, trait-specific feature data can be extracted and used to evaluate different traits. Depending on the specific trait being evaluated, the feature extraction may use either individual or combined inputs, as noted-above. Further, owing to the distinct nature of quantitative and qualitative traits, the feature extraction may employ different algorithms and techniques and deep learning models that process various animal body parts or viewing angles concurrently. For a single trait, an ensemble of algorithms or models may also be used.

### (ii) Example Landmark Detection Model

Reference is made to FIG. 5, which shows an example architecture (500) for 2D landmark detection using machine learning and deep neural networks. Architecture (500) can be used to implement act (306c), in FIG. 3C. The output of the process (500) is a 2D image that is annotated with the landmarks of interest.

Architecture (500) can be reflective of one or more of: (i) an example generic landmark detection model, e.g., for all use cases: (ii) an example animal-specific landmark detection model; and/or (iii) an example body part-specific landmark detection model.

As shown, a 2D input image (502) is fed into a backbone network (504). Depending on the application of the model and how the model is trained, this 2D input image can be: (i) an entire image of animal (or any portion thereof). For example, this can be an output image from one or more of the object detection model (302c) and/or body part detection model (304c) in FIG. 3C; (ii) a cropped body part image, showing only a single body part, e.g., cropped from FIG. 6E.

The backbone network (504) is responsible for feature extraction from the input image (502), which assists in detecting key landmarks of interest for different body parts.

The backbone network (504) utilizes various trained deep learning models to learn and extract useful features from the input image (502). These features include edges, textures, and other relevant patterns relevant to landmark detection.

In some examples, the backbone network (504) can utilize different pre-trained networks or a combination therefore. By way of example, the pre-trained networks include LEAP, Stacked Hourglass, ResNet-50, ResNet-101, ResNet-152, and transformer backbones such as ViT, DETR, and CPVT. In at least one example, a ResNet-50 network is used to balance accuracy and computational speed.

From backbone network (504), the extracted features are passed on to subsequent head network (506) comprised of layers of a convolutional neural network (CNN) (507). Broadly, the head network (506) is responsible for recognizing specific indicia (e.g., features or patterns) in images that correspond to candidate landmarks of interest.

The head network (506) may be trained using a large dataset of annotated training images for various animal types, whereby the coordinates of the landmarks are already pre-specified in the training images. During training, the network learns to identify the key features associated with each landmark, such as the shape and texture of the surrounding area.

In at least one example, the CNN (507) in head network (506) can use pixel-wise landmark detection, which involves determining the exact location of a landmark at the level of individual pixels in an image.

In other examples, the CNN (507) in head network (506) can employ region-wise landmark detection. This involves detecting candidate landmarks by analyzing larger image regions defined by masks (508), which are likely to contain the landmark of interest.

It is believed that this approach is less computationally expensive than pixel-wise landmark detection and can be more robust to variations in lighting, occlusions, and noise. Additionally, region-wise landmark detection may be more suitable for detecting landmarks defined based on the overall shape or structure of an object.

In some cases, use of small masks in the region-wise landmark detection can allow detecting smaller landmarks with greater accuracy. However, smaller masks may be more sensitive to noise and occlusions and may not capture enough context around the landmark, leading to reduced accuracy.

Conversely, using larger masks can capture more context around the landmark, improving accuracy, but they may not be suitable for detecting smaller landmarks or features. Due to their ability to capture more context around the landmark, larger masks may require less training data as compared to smaller masks, reducing the need for a large amount of training data.

In accordance with embodiments disclosed herein, masking (508) uses a unique combination of small, medium, and large masks in region-wise landmark detection (e.g., three sizes of masks of graduating increasing pixel size).

In at least one example, the region-wise landmark detection (508) uses three different masks. These masks can have sizes of 3×3 (small), 5×5 (medium), and 7×7 (large) pixels. This combination of masks may enable improved accuracy in detecting landmarks, as the small mask can detect landmarks more accurately, while the medium and large masks can capture more context around landmarks, improving overall accuracy. Furthermore, the use of medium and large masks that require less training data compared to small masks allows the CNN (507) in head network (506) to be trained for small masks with a smaller amount of training data.

In some embodiments, head network (506) can initially determine a confidence score for each detected candidate landmark, in each mask. After that, at (510), the candidate landmarks detected in the small, medium, and large masks (508) are selected based on the highest confidence score, and that is selected as the final detected landmark in that region. This can be iterated for a plurality of overlapping regions. If a detected landmark has a confidence score that falls below a specified threshold, it can be reported as an invisible or low-confidence landmark.

The output result of the landmark detection (500) can be a list of pixel coordinates of all the detected landmarks (514). Depending on the input image, the output can be: (i) the 2D image of the animal (512), accompanied (e.g., annotated) with generic or animal-specific landmarks (514); and/or (ii) 2D image of the input cropped body part image, accompanied (e.g., annotated) with body part-specific landmarks.

In at least one example, a CNN model with 86 million parameters and a computational complexity of 6.8 GFLOPs was utilized in head network (506) for dairy cow conformation trait scoring.

In some embodiments, if the video frames are used for the evaluation, tracking techniques can be utilized to track the detected landmarks from one frame to the next, which can reduce processing time and workload.

In at least one example, the landmark detection architecture (500) is animal-specific. That is, a separate head network (506) need to be trained for different animals. The appropriate landmark detection architecture (500) can be selected based on the target animal being evaluated. In addition or in the alternative, the landmark detection architecture (500) is body part-specific. That is, a separate head network (506) is trained for different body parts (e.g., across all animals, or animal-specific body parts). The same backbone network (504) is used for all animals or specific body parts of different animals.

### (iii) Previously Captured Sensor Data

While methods (300a)-(300d) (FIGS. 3A-3D) rely on operating sensors to capture sensor data (e.g., act (304a) in FIG. 3A, and act (302b) in FIG. 3B)—in other embodiments, the methods can operate on previously captured sensor data.

That is, the methods can be applied after the fact, to analyze sensor data captured at a previous instant in time. This sensor data may be stored on a memory or database, such a memory of server (106).

In these examples, at acts (304a) in FIG. 3A, as well as acts (302b), (316b) in FIG. 3A and/or (326b) in FIG. 3B, the system can retrieve or access the previously captured sensor data.

### V. EXAMPLE GRAPHICAL USER INTERFACES (GUIs)

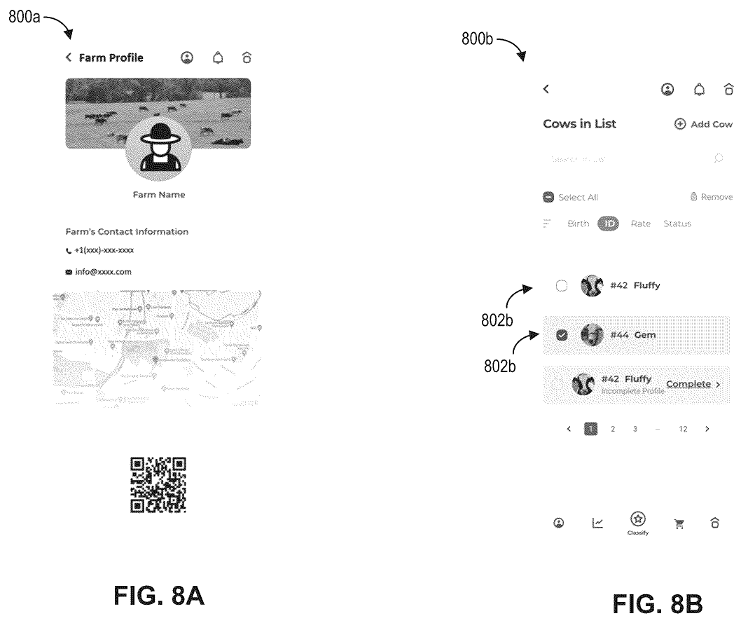

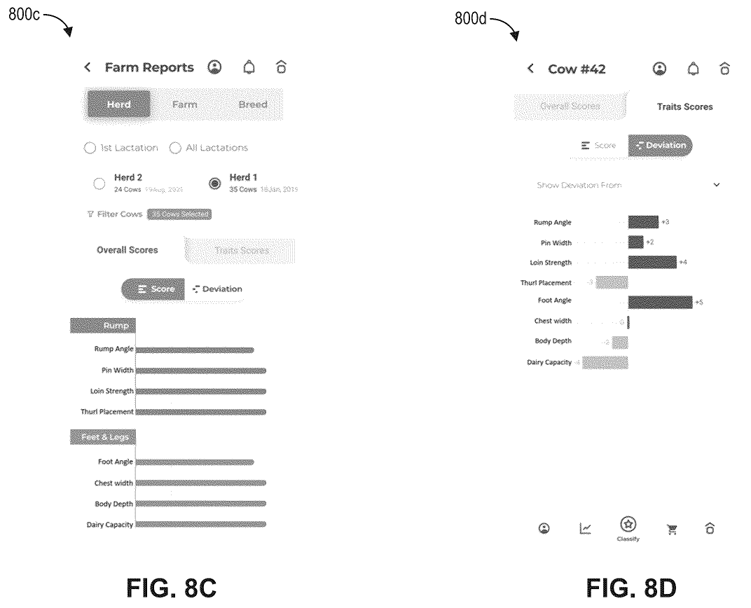

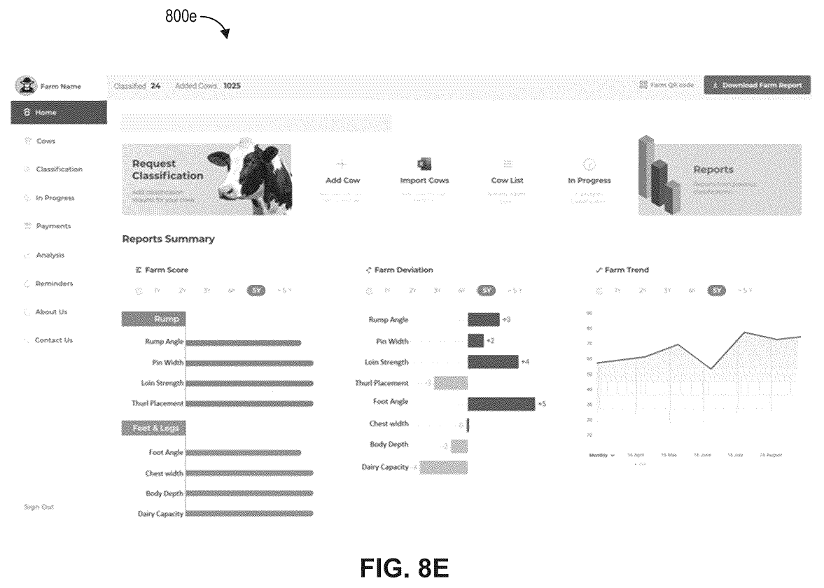

FIGS. 8A-8D illustrate various screenshots that can be displayed as part of a graphical user interface (GUI); associated with a mobile application (see e.g., interfaces on user devices (104b) and (104c) in FIG. 1).

FIG. 8A shows a screenshot (800a) that represents a farm's profile. FIG. 8B shows a screenshot (800b), which can identify various animal profiles (802b) in association with the farm. FIGS. 8C and 8D shows screenshots (800c) and (800d), which include aggregate evaluation scores and data (e.g., average scores and score deviations) related to traits for cow herds located on the farm. This can be generated based on analyzing trait scores for individual cow profiles.

FIG. 8E shows a screenshot (800e) of an example desktop interface that can also display various aggregate farm data.

### VI. EXAMPLE HARDWARE CONFIGURATIONS

The following is a description of example hardware configurations for the automated evaluation assembly (AEA) (102) and a user device (104).

### (i) Example Hardware Configuration for Automated Evaluation Assembly (AEA)

Reference is made to FIG, 9A, which shows an example hardware configuration for an automated evaluation assembly (AEA) (102).

As shown, the AEA (102) can include the controller (114). Controller (114) can include a processor (902a) coupled to a memory (904a).

As used herein, “processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors. The term “processor” may be used interchangeably with “at least one processor” and/or “one or more processors”.

As used herein, a “memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

It will be understood by those of skill in the art that references herein to AEA (102) as carrying out a function or acting in a particular way imply that processor (902a) is executing instructions (e.g., a software program) stored in memory (904a) and possibly transmitting or receiving inputs and outputs via one or more interfaces.

Controller (114) is further coupled to one or more of: (i) sensor subsystem (110); (ii) arm holder control subsystem (906a); (iii) gate control subsystem (914a); (iv) display interface (912a); (v) communication interface (908a) and/or an input interface (910a).

Sensor subsystem (110) can include one or more sensors, which may be mounted to the frame (112) of the AEA (102) (FIGS. 2A-2C). The sensors can include, 2D imaging sensors (110a), depth sensors (110b), infrared and/or thermal sensors (110c), as well as other sensors (e.g., temperature sensors, weight sensors, ultrasonic range sensors). In some examples, one or more of the sensors (110) can be integrated into a single sensor unit.

More generally, two-dimensional (2D) imaging sensors (110a) can include any sensor for capturing 2D image data. This can include sensors for capturing color image data (e.g., RGB image sensors), or black and white image data, and include video cameras. In some examples, the 2D imaging sensors include monocular cameras and/or webcams.

Depth sensors (110b) can include any type of sensor for capturing distance (or depth) data. These include various types of time-of-flight (ToF) sensors, which include LiDAR (Light Detection and Ranging) enabled sensor technology, as known in the art (e.g., Microsoft Kinect™ sensors), Depth sensors (110b) may also include structure light cameras, as also known in the art (e.g., ASUS Xtion PRO Live™ or Occupital® Structure Sensor™). In some examples, the depth sensor (110b) is integrated into the 2D imaging sensor (110a), such as is the case for an RGB depth RGB-D) camera (e.g., Intel RealSense™ camera or Sterelabs ZED series™ camera).

In some example, as noted previously, controller (114) can drive the sensor system (110) synchronously to capture sensor data (e.g., images) of the animal in a master-slave configuration. In this case, the controller (114) acts as the master, and the sensor system (110) is triggered synchronously as the “slaves”.

Arm holder control subsystem (906a) can include various motor and/or gears for controlling motion and positioning of arm holders (208) (FIGS. 2A-2B). As discussed previously, arm holders (208) can be used to mount sensors, and can be manipulated to alter the location and/or angle of the sensor. This enables capturing sensor data of an animal (108) from various views and angles.

In some examples, the arm holder control subsystem (906a) can control various angular joints on arms (208), as well as sliding of the arms (208) along the AEA frame (112).

Communication interface (908a) may comprise a cellular modem and antenna for wireless transmission of data to the communications network (e.g., network (105) in FIG. 1).

Input interface (710a) can be any interface for receiving user inputs (e.g., a keyboard, mouse, touchscreen, etc.). In some examples, the display and input interface or one of the same (e.g., in the case of a touchscreen display, such as a capacitive touchscreen).

Display interface (912a) can be an output interface for displaying data (e.g., an LCD screen).

Gate control subsystem (914a) can also include various motors and/or gears for controlling opening and closing of the gate (204a).

### (ii) Example Hardware/Software Configuration for User Device

Reference is made to FIG. 9B, which shows an example hardware configuration for a user device (104).

As shown, the user device (104) can also include a processor (902b) coupled to a memory (904b), and one or more of sensor subsystem (110), a communication interface (906b), an input interface (908b) and a display interface (910b).

It will be understood by those of skill in the art that references herein to user device (104) as carrying out a function or acting in a particular way imply that processor (902b) is executing instructions (e.g., a software program) stored in memory (904b) and possibly transmitting or receiving inputs and outputs via one or more interfaces.

In some examples, the memory (904b) can store a software application or program (906b), which performs various functions described above.

Sensor subsystem (110), communication interface (906b), input interface (708b) and display interface (910b) can be generally analogous in structure and function to the similar components described for the AEA (102) (FIG. 7A).

### (iii) Example Hardware/Software Configuration for Server

While not explicitly illustrated, the server (106) may also include a processor (e.g., at least one server processor) coupled to a memory, as well as a communication interface. In some examples, server (106) can also include a storage database coupled to the memory, for storing various animal profiles as well as animal data (e.g., raw sensor data, derived sensor data, extracted feature data, as well as evaluation scores).

### VII. INTERPRETATION

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90. 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a push button keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application; built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, users of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modifications and variations may be made to these exemplary embodiments without departing from the spirit and scope of the invention, which is limited only by the appended claims.

1. A method for automated evaluation of animals, comprising:
accessing sensor data acquired of an animal;
analyzing the sensor data to generate derivative sensor data;
applying feature extraction to one or more of the sensor data and derivative sensor data to extract trait-specific feature data associated with one or more target traits used for evaluating the animal; and
generating one or more evaluation scores for the animal, for each of the one or more target traits, based on the extracted trait-specific feature data for these target traits.

2. The method of claim 1, wherein the sensor data comprises one or more of:
two-dimensional (2D) image data generated by one or more 2D imaging sensors;
depth sensor data generated by one or more depth sensors; and
infrared (IR) sensor data generated by one or more IR sensors; and
depth sensor data generated by applying monocular depth estimation to the two-dimensional (2D) image data.

3. The method of claim 2, wherein generating the derivative sensor data comprises generating derivative 2D image sensor data by:
applying a trained object detection machine learning model to the 2D image data to generate an object annotated 2D image with indicia of the location of the animal in the 2D image;
applying a trained body part detection machine learning model to the object annotated 2D image to generate a body part annotated 2D image, the body part annotated 2D image comprising indicia of the locations of different animal body parts; and
applying a trained landmark detection machine learning model to the body part annotated 2D image to generate landmark data.

4. The method of claim 3, wherein the applying the landmark detection machine learning model comprises:
applying a trained backbone network which receives the 2D image data and extracts one or more features relevant to landmark detection;
applying a trained head network comprising a convolutional neural network (CNN), wherein the CNN receives the extracted features and the 2D image, and identifies indicia corresponding to candidate landmarks,
wherein the CNN applies region-wide landmark detection using three sizes of masks, and further, determines a confidence score for each detected candidate landmark detected in each mask size; and
selecting; from the candidate landmarks, the landmark with highest score for each instance of the region-wise landmark detection.

5. The method of claim 4, wherein generating the derivative 2D image sensor data further comprises:
applying, to the object annotated 2D image, three-dimensional (3D) pose estimation to generate 3D pose estimation data.

6. The method of claim 5, further comprising applying 2D feature extraction based on one or more of: (i) the object annotated 2D image, (ii) the body part annotated 2D image, (iii) the landmark data and (iv) the 3D pose estimation data, to extract one or more features related to the one or more target traits.

7. The method of claim 2, wherein generating the derivative sensor data comprises generating derivative depth sensor data by:
optionally, converting depth sensor data of the animal into point cloud data;
applying 3D coordinate registration to the point cloud data to generate registered point cloud data;
using the 3D coordinate registered data to generate a 3D model reconstruction of the animal; and
applying 2D to 3D landmark projection to generate 3D landmark data.

8. The method of claim 7, further comprising applying 3D feature extraction based on one or more of: (i) the registered point cloud data; (ii) the reconstructed 3D model data; and (iii) the 3D landmark data, to extract one or more features related to the one or more target traits.

9. The method of claim 2, further comprising:
applying IR pixel mapping calibration between the IR data and the 2D image to generate IR pixel mapped image data; and
applying IR feature extraction to one or more of: (i) IR data; and (ii) IR pixel mapped data.

10. The method of claim 1, wherein the one or more evaluation scores are stored in association with an animal profile, and the evaluation scores are output on a display interface of a user device.

11. A system for automated evaluation of animals, comprising:
an evaluation apparatus comprising one or more sensors, and at least one processor coupled to the one or more sensors, the at least one processor being configured for:
operating the one or more sensors to generate sensor data of an animal being evaluated; and
transmitting the sensor data to at least one server; and
the at least one server comprising at least one server processor configured for:
receiving the sensor data from the evaluation apparatus;
analyzing the sensor data to generate derivative sensor data;
applying feature extraction to one or more of the sensor data and derivative sensor data to extract trait-specific feature data associated with one or more target traits used for evaluating the animal; and
generating one or more evaluation scores for the animal, for each of the one or more target traits, based on the extracted trait-specific feature data for these target traits.

12. The system of claim 11, wherein the evaluation apparatus comprises one or more of an automated evaluation assembly (AEA), and a user device.

13. The system of claim 12, wherein the at least one processor of the evaluation apparatus is included in a controller of the AEA, and the AEA further comprises: (i) a frame structure for supporting the one or more sensors; and (ii) an area for receiving the animal being evaluated, and
wherein the user device hosts a mobile application which is executed by the at least one processor, the mobile application being configured to operate the one or more sensors, and transmit the sensor data to the at least one server, the mobile application also being configured to receive the evaluation scores from the at least one server and display the evaluation scores on a display interface of the user device.

14. The system of claim 11, wherein the one or more sensors include two-dimensional (2D) imaging sensors configured to generate 2D image data, and generating the derivative sensor data comprises the at least one server processor being further configured for generating derivative 2D image sensor data by:
applying a trained object detection machine learning model to the 2D image data to generate an object annotated 2D image, with indicia of the location of the animal in the 2D image;
applying a trained body part detection machine learning model to the object annotated 2D image to generate a body part annotated 2D image, wherein the body part annotated 2D image includes indicia of the locations of different animal body parts; and
applying a trained landmark detection machine learning model to the body part annotated 2D image to generate landmark data.

15. The system of claim 14, wherein the applying the landmark detection machine learning model comprises the at least one server processor being further configured for:
applying a trained backbone network which receives the 2D image data and extracts one or more features relevant to landmark detection;
applying a trained head network comprising a convolutional neural network (CNN), wherein the CNN receives the extracted features and 2D image data, and identifies indicia corresponding to candidate landmarks,
wherein the CNN applies region-wide landmark detection using three sizes of masks, and further, determines a confidence score for each detected candidate landmark detected in each mask size; and
selecting, from the candidate landmarks, the landmark with highest score for each instance of the region-wise landmark detection.

16. The system of claim 15, wherein the at least one processor is further configured for:
applying 2D feature extraction based on one or more of: (i) the object annotated 2D image, (ii) the body part annotated 2D image, (iii) landmark data and (iv) 3D pose estimation data, to extract one or more features related to the one or more target animal traits.

17. The system of claim 11, wherein the one or more sensors include sensors for generating depth data, and generating the derivative sensor data comprises the at least one server processor being further configured for generating derivative depth sensor data by:
optionally, converting depth data of the animal into point cloud data;
applying 3D coordinate registration to the point cloud data to generate registered point cloud data;
using the 3D coordinate registered data to generate a 3D model reconstruction of the animal; and
applying 2D to 3D landmark projection to generate 3D landmark data, wherein the depth data is optionally generated by applying monocular depth estimation to two-dimensional (2D) image data of the animal.

18. The system of claim 17, further comprising the at least one server processor being further configured for:
applying 3D feature extraction based on one or more of: (i) registered point cloud data; (ii) reconstructed 3D model data; and (iii) 3D landmark data, to extract one or more features related to the one or more target animal traits.

19. The system of claim 11, wherein the one or more sensors include IR sensors for generating IR data, and generating the derivative sensor data comprises the at least one server processor being further configured for generating derivative IR sensor data by:
applying IR pixel mapping calibration between the IR data and the 2D image to generate IR pixel mapped image data; and
applying IR feature extraction to one or more of: (i) IR data; and (ii) IR pixel mapped data

20. An evaluation apparatus for evaluating animals comprising:
one or more sensors;
at least one processor coupled to the one or more sensors, and configured for:
accessing sensor data acquired of the animal;
analyzing the sensor data to generate derivative sensor data;
applying feature extraction to one or more of the sensor data and derivative sensor data to extract trait-specific feature data associated with the one or more target traits used for evaluating the animal; and
generating one or more evaluation scores for the animal, for each of the one or more target traits, based on the extracted trait-specific feature data for these target traits.
